(19) United States
(12) Patent Application Publication
(10) Pub. No.: US 2025/0232380 A1
(43) Pub. Date: Jul. 17, 2025

(54) AUTOMATED SYSTEM AND METHOD FOR COMPARING INSURANCE DOCUMENTS, HIGHLIGHTING SIMILARITIES AND VARIANCES, RECOMMENDING AN OPTIMUM INSURANCE COVERAGE, AND DELIVERING PLACEMENT INSIGHTS

(71) Applicant: BLUEPOND AI, INC., Wilmington, DE (US)

(72) Inventors: Pranav Pasricha, Basking Ridge, NJ (US); Venkatesh Srinivasan, Chennai (IN); Sachin Kachare, Chennai (IN); Kanchana Vijaykumar, Chennai (IN); Vamshee Krishna, Chennai (IN); Abilash Mathew, Chennai (IN)

(21) Appl. No.: 18/984,289

(22) Filed: Dec. 17, 2024

Related U.S. Application Data
(60) Provisional application No. 63/612,182, filed on Dec. 19, 2023.

(51) Int. Cl. G06Q 40/08

(52) U.S. Cl. CPC G06Q 40/08

(57) ABSTRACT

The present disclosure relates to a system and a method for comparing two or more insurance documents. The system comprises a server that is configured for obtaining two or more insurance documents and a consumer data, determining a plurality of entities from each insurance document by analyzing each insurance documents, augmenting the plurality of entities using data from third part data sources, contextualizing and summarizing contents of the two or more insurance documents using clause and domain specific prompt libraries, and comparing a plurality of augmented entities and a plurality of clauses across the plurality of insurance documents to find similarities and differences and summarizing compared data, and providing comparison result and recommending an optimum insurance product. The present disclosure also provides placement insights generated from a plurality of processed historical policy and quote data.

### CROSS-REFERENCE TO RELATED APPLICATION

This application claims the benefit of U.S. Provisional Application Ser. No. 63/612,182, filed on Dec. 19, 2023, entitled “AUTOMATED SYSTEM AND METHOD FOR COMPARING AND CHECKING QUOTES AND POLICIES, RECOMMENDING AN OPTIMUM INSURANCE COVERAGE, AND DELIVERING PLACEMENT INSIGHTS,” commonly assigned with this application and incorporated herein by reference in its entirety.

### FIELD OF THE DISCLOSURE

The present disclosure generally relates to data processing systems. More specifically, the present disclosure relates to a system and a method for comparing a plurality of insurance documents, highlight similarities and variance across the insurance documents, and recommending an optimum insurance coverage according to a customer profile and insurer's risk to appetite. The system and method of the present disclosure also generates placement insights for insurance brokers based on a plurality of processed historical quote and policy data and provides recommendation in selecting insurance products and/or insurance carriers according to a line of business.

### BACKGROUND

Insurance is a contract in which an insurer (e.g., insurance company) agrees to indemnify an insured (i.e., consumer) against losses arising from specific contingencies or perils. There are several types of insurance products available for an individual (e.g., personal insurance) as well as for a business (e.g., commercial/business insurance) to protect them from a financial loss. Typically, consumers seeking an insurance product turn to an insurance agent or an insurance broker to obtain a quote for an insurance premium and identify an appropriate insurance policy. It is important to identify the appropriate insurance policy as different insurers offer different insurance policies and quotes for a specific insurance product. One insurer differs from another insurer in terms of conditions, exclusions, obligations, deductible amount, coverage amount, and insurance premium, etc. For example, with respect to automobile insurance, one insurer may cover damages due to natural disaster, but another insurer may not.

Contemporarily, the insurance agents or brokers determine the appropriate insurance policy and the quote by analyzing a plurality of insurance policies and quotes from same company or carrier or different insurance companies manually. Nevertheless, manual analysis of policies and quotes leads to errors and omissions (E&O). Such oversights pose E&O liabilities to the insurance agents or brokers and result in suboptimal coverage or cost for insureds. Further as part of an insurance process, the insurance agents or brokers face challenges related to time, effort, and accuracy while cross checking binders or policies with expiring policies. Due to inaccuracies in policies and missed features when selecting an insurance policy or an insurer, the insured face coverage gaps, thereby the insured is not protected against certain risks. Further, increase in volume of specialized insurance, particularly excess and surplus lines with wide variation in coverage, the insurance agents or brokers don't always fully understand policy terms and conditions and cannot advise customers effectively. Furthermore, the insurance agents or brokers are not able to spend enough time on subjective information comparison which is important for making decisions like inclusions, terms, and exclusions on each quote which in turn causes huge financial implications to insurers or insureds.

Some existing approaches automates a process of policy and quotes checking. However, such existing approaches do the policy and quotes checking on a high level by analyzing few parameters of the policies and quotes. For example, the existing approaches primarily focus on price, potentially sidelining other important factors like coverage depth, inclusions, and exclusions etc. Accordingly, such approaches do not provide appropriate insight to the insured and/or the insurance agents or brokers and still require human intervention.

Some existing approaches perform word by word comparison of policy and quote documents, thereby the existing approaches do not understand the relationship between sections in the same document. For example, if there is a policy clause that modifies an exclusion mentioned in an earlier page, the existing approaches will not be able to understand the relationship and will consider this as a new piece of information. Similarly, the existing approaches will not be able to understand a context of information for different endorsements which are spread throughout the quote or policy documents. Accordingly, such existing approaches may provide incorrect quotes or policy recommendations.

Further, the existing approaches do not perform personalized policy and quotes checking. Rather, the existing approaches provide generalized quotes based on limited information. Further, existing approaches do not verify input policy and quote data, thereby existing approaches rely on inaccurate data often. In addition, the existing approaches are not able to customize policies to unique needs of the customer by leveraging historical information for similar customers, lines of business etc.

Therefore, a need exists for a system and method for automatically comparing insurance policies and/or quotes and recommending an optimum insurance quote according to a customer profile and insurers risk to appetite option.

### SUMMARY

In one aspect, the present disclosure discloses a system for analyzing insurance documents, highlighting similarities and differences across the insurance documents, and recommending an optimum insurance coverage. The system comprises a server comprising a memory to store one or more modules and a processor configured to execute the one or more modules to perform one or more functions of the system. The processor is configured to receive two or more insurance documents associated with insurance products from a user device, determine a plurality of entities from each insurance document using a combination of one or more machine learning models and one or more large language models, augment, using an augmentation module, the plurality of entities using data from third part data sources, contextualize and summarize, using a contextualizing and summarizing module, contents of a plurality of clauses of the two or more insurance documents at a document level using a clause library and a domain specific prompt library, compare, using a comparison module, a plurality of augmented entities and the plurality of clauses by leveraging contextualized and summarized contents of the two or more insurance documents, across the two or more insurance documents, and generate, on a user interface, a side-by-side comparison of the plurality of augmented entities and the plurality of clauses across the two or more insurance documents based on comparison of the two or more insurance documents. The insurance documents include at least one of an insurance quote document, an insurance policy document, an insurance contract, a certificate of insurance (COI) request form, or combination thereof. The plurality of entities correspond to at least one of an quote information, a policy information, an insurance contract information, an insurance request information or combination thereof

In some embodiments, receiving the two or more insurance documents from the user device, the processor is configured to classify, using a classification, transformation and enhancing (CTE) module, each insurance document based on a type and a line of business that each insurance document associated with, identify, using a context filtering module, one or more pages of each insurance document comprising at least one of a quote data, a policy data, or an insurance contract data, a COI request data, or combination thereof, and trigger, using a triggering module, one or more models for comparison of the two or more insurance documents based on classification of each insurance document and identified pages of each insurance document. The processor is further configured to provide identified pages of each insurance document as an input to triggered one or more models.

In some embodiments, the processor determines the plurality of entities from each insurance document by identifying, using an entity recognition module, the plurality of entities that are immediately apparent from the two or more insurance documents using the domain specific prompt library, determining, using quote and policy models, relationship between identified entities and the plurality of clauses, further, to determine whether changes in clauses impact applicability, values, and interactions of the identified entities within the insurance documents, and contextualizing and extracting, using a contextual extraction module, the plurality of entities that are not be immediately apparent in the two or more insurance documents by leveraging relationship determined by the quote and policy models.

In some embodiments, the processor is further configured to color code differences and similarities across the two or more insurance documents with respect to entities and clauses associated with each insurance document.

In some embodiments, the processor is further configured to generate, on the user interface, a side-by-side comparison across source documents of the two or more insurance documents with respect to entities and clauses associated with each insurance document.

In some embodiments, the plurality of entities comprises at least one of a name of an insured, an address of the insured, a policy number, a name of a carrier, a location schedule, an agency name and address, terrorism, limits, premium, dates, deductibles, exclusions, endorsements, coverage types, a name of COI requester name, an address of COI requester, a name of COI holder, an address of COI holder, a project information, or combination thereof.

In some embodiments, the plurality of clauses comprises at least one of an exclusion clause, an endorsement clause, definitions, coverage terms, conditions, limitations, premium payment terms, a cancellation clause, a renewal clause, a dispute resolution clause, a territorial limits clause, subrogation, co-insurance clause, or a liability clause.

In some embodiments, the processor is further configured to summarize, using a summarization module, a comparison data of the two or more insurance documents.

In some embodiments, when the two or more insurance documents comprise at least one of two or more insurance quote documents, corresponding two or more insurance policy documents, or combination thereof, the processor is further configured to recommend, using a recommendation module, the optimum insurance coverage by leveraging comparison data of the two or more insurance documents.

In some embodiments, the processor is further configured to generate placement insights by analyzing a plurality of historical insurance products opted by various customers in different line of business and determining trends and patterns of at least one of purchasing of coverages, limits, premium ranges, and endorsements, purchasing of insurance products, common exclusions, top carriers by premium, top brokers by carrier according to a line of business.

In some embodiments, the processor is further configured to recommend at least one of optimum insurance products, insurance carriers, insurance brokers, or an insurance market for a customer based on the placement insights and obtain the plurality of insurance documents based on recommended insurance products and/or insurance carriers or market, for comparison.

In some embodiments, the processor is further configured to recommend, using the recommendation module, the optimum insurance coverage based on comparison of the two or more insurance documents as well as based on at least one of the placement insights, north american industry classification system (NAICS) code or standard industrial classification (SIC) code, revenue and other business profile, state or jurisdiction of operations a line of business, and insurer's risk to appetite.

In some embodiments, when the two or more insurance documents comprise a new insurance policy and at least one of prior year insurance policy, the processor is configured to identify at least one of errors and omissions, and any coverage gaps in the new insurance policy over the at least one of prior year insurance policy by leveraging comparison data of the two or more insurance documents, and communicate identified errors and omissions and/or any coverage gaps to corresponding parties to revise quote offering and/or policies, wherein revised quote offering and/or policies are further used for comparison.

In some embodiments, when the two or more insurance documents comprise the insurance contract and the COI request form, the processor is further configured to generate, using a COI generation module, a certificate of insurance (COI) by leveraging comparison data of the two or more insurance documents, wherein the COIS, wherein the COI provides a proof of insurance coverage for an insured.

In some embodiments, the processor is further configured to create, using a scoring module, an accuracy score indicating an accuracy of extracted information across the insurance documents and an automation score indicating level of automation achieved in identifying, extracting, comparing, and summarizing data across the insurance documents.

In another aspect, the present disclosure provides a computer implemented method for analyzing insurance documents, highlighting similarities and differences across the insurance documents and recommending an optimum insurance coverage. The method comprises step of: receiving two or more insurance documents associated with insurance products from a user device, determining a plurality of entities from each insurance document using a combination of one or more machine learning models and one or more large language models, augmenting, using an augmentation module, the plurality of entities using data from third part data sources, contextualizing and summarizing, using a contextualizing and summarizing module, contents of a plurality of clauses of the two or more insurance documents at a document level using a clause library and a domain specific prompt library, comparing, using a comparison module, a plurality of augmented entities and the plurality of clauses by leveraging contextualized and summarized contents of the two or more insurance documents across the two or more insurance documents, and generating, on a user interface, a side-by-side comparison of the plurality of augmented entities and the plurality of clauses across the two or more insurance documents based on comparison of the two or more insurance documents. The insurance documents include at least one of an insurance quote document, an insurance policy document, an insurance contract, a certificate of insurance (COI) request form, or combination of thereof. The plurality of entities correspond to at least one of an quote information, a policy information, an insurance contract information, an insurance request information or combination thereof.

In some embodiments, the method comprises, after receiving the two or more insurance documents from the user device, classifying, using a classification, transformation and enhancing (CTE) module, each insurance document based on a type and a line of business that each insurance document associated with, identifying, using a context filtering module, one or more pages of each insurance document comprising at least one of a quote data, a policy data, or an insurance contract data, a COI request data, or combination thereof, and triggering, using a triggering module, one or more models for comparison of the two or more insurance documents based on classification of each insurance document and identified pages of each insurance document. The method further comprises providing identified pages of each insurance document as an input to triggered one or more models.

In some embodiments, the method determines the plurality of entities from each insurance document by identifying, using an entity recognition module, the plurality of entities that are immediately apparent from the two or more insurance documents using the domain specific prompt library, determining, using quote and policy models, relationship between identified entities and the plurality of clauses, further, to determine whether changes in clauses impact applicability, values, and interactions of the identified entities within the insurance documents, and contextualizing and extracting, using a contextual extraction module, the plurality of entities that are not be immediately apparent in the two or more insurance documents by leveraging relationship determined by the quote and policy models.

In some embodiments, the method further comprises color coding differences and similarities across the two or more insurance documents with respect to entities and clauses associated with each insurance document.

In some embodiments, the method further comprises generating, on a user interface, a side-by-side comparison across source documents of the two or more insurance documents with respect to entities and clauses associated with each insurance document.

In some embodiments, the plurality of entities comprises at least one of a name of an insured, an address of the insured, a policy number, a name of a carrier, a location schedule, an agency name and address, terrorism, limits, premium, dates, deductibles, exclusions, endorsements, coverage types, a name of COI requester name, an address of COI requester, a name of COI holder, an address of COI holder, a project information, or combination thereof.

In some embodiments, the plurality of clauses comprises at least one of an exclusion clause, an endorsement clause, definitions, coverage terms, conditions, limitations, premium payment terms, a cancellation clause, a renewal clause, a dispute resolution clause, a territorial limits clause, subrogation, co-insurance clause, or a liability clause.

In some embodiments, the method further comprises summarizing, using a summarization module, a comparison data of the two or more insurance documents.

In some embodiments, the method further comprises, when the two or more insurance documents comprise at least one of two or more insurance quote documents, corresponding two or more insurance policy documents, or combination thereof, recommending, using a recommendation module, the optimum insurance coverage by leveraging comparison data of the two or more insurance documents.

In some embodiments, the method further comprises generating placement insights by analyzing a plurality of historical insurance products opted by various customers in different line of business and determining trends and patterns of at least one of purchasing of coverages, limits, premium ranges, and endorsements, purchasing of insurance products, common exclusions, top carriers by premium, top brokers by carrier according to a line of business.

In some embodiments, the method further comprises recommending at least one of optimum insurance products, insurance carriers, insurance brokers, or an insurance market for a customer based on the placement insights and obtaining the plurality of insurance documents based on recommended insurance products and/or insurance carriers or market, for comparison.

In some embodiments, the method further comprises recommending, using the recommendation module, the optimum insurance coverage based on comparison of the two or more insurance documents as well as based on at least one of the placement insights, north american industry classification system (NAICS) code or standard industrial classification (SIC) code, revenue and other business profile, state or jurisdiction of operations a line of business, and insurer's risk to appetite.

In some embodiments, the method, when the two or more insurance documents comprise a new insurance policy and at least one of prior year insurance policy, further comprises identifying at least one of errors and omissions, and any coverage gaps in the new insurance policy over the at least one of prior year insurance policy by leveraging comparison data of the two or more insurance documents and communicating identified errors and omissions and/or any coverage gaps to corresponding parties to revise quote offering and/or policies, wherein revised quote offering and/or policies are further used for comparison.

In some embodiments, the method further comprises creating, using a scoring module, an accuracy score indicating an accuracy of extracted information across the insurance documents and an automation score indicating level of automation achieved in identifying, extracting, comparing, and summarizing data across the insurance documents.

In yet another aspect, the present disclosure provides a computer program product comprising a non-transitory computer-readable storage medium having computer-readable instructions stored thereon, computer-readable instructions being executable by a computerized device comprising processing hardware to execute a method comprising steps of: receiving two or more insurance documents associated with insurance products from a user device, determining a plurality of entities from each insurance document using a combination of one or more machine learning models and one or more large language models, augmenting, using an augmentation module, the plurality of entities using data from third part data sources, contextualizing and summarizing, using a contextualizing and summarizing module, contents of a plurality of clauses of the two or more insurance documents at a document level using a clause library and a domain specific prompt library, comparing, using a comparison module, a plurality of augmented entities and the plurality of clauses by leveraging contextualized and summarized contents of the two or more insurance documents across the two or more insurance documents, and generating, on a user interface, a side-by-side comparison of the plurality of augmented entities and the plurality of clauses across the two or more insurance documents based on comparison of the two or more insurance documents. The insurance documents include at least one of an insurance quote document, an insurance policy document, an insurance contract, a certificate of insurance (COI) request form, or combination of thereof. The plurality of entities correspond to at least one of an quote information, a policy information, an insurance contract information, an insurance request information or combination thereof.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Embodiments of the present disclosure may best be understood by referring to the following description and accompanying drawings that are used to illustrate the present disclosure wherein like reference numerals refer to similar elements throughout the Figures. In the drawings:

FIG. 1 is a block diagram that illustrates a system for comparing insurance documents in accordance with the present disclosure.

FIG. 2 is a block diagram that illustrates one or more modules of a server of FIG. 1 in accordance with the present disclosure.

FIG. 3 is a flowchart that illustrates a method for comparing insurance documents in accordance with the present disclosure.

FIG. 4 is a schematic diagram of an exemplary user interface that displays a comparison results of insurance quotes for a plurality of customers in accordance with the present disclosure.

FIG. 5 is a schematic diagram of an exemplary user interface that displays a summary, an automation score, no. of parameters that are matching and mismatching, quotes recommendation, and quotes comparison for a first customer in accordance with the present disclosure.

FIG. 6 is a schematic diagram of an exemplary user interface that displays a source document (e.g., policy document) highlighting mismatches in accordance with the present disclosure.

FIGS. 7A-7C are schematic diagrams of exemplary user interfaces that display a comparison of quotes across a plurality of entities in accordance with the present disclosure.

FIGS. 8A-8C are schematic diagrams of exemplary user interfaces that display a summary and comparison of new or renewing policy and associated quote with existing policies in accordance with the present disclosure.

FIGS. 9A-9C are schematic diagrams of exemplary user interfaces that display trends or patterns and insights regarding insurance products and insurance carriers according to a line of business, in accordance with the present disclosure.

FIG. 10 illustrates a hardware configuration of a server/computer system/computing device for practicing embodiments of the present disclosure.

### DETAILED DESCRIPTION

Embodiments of the present disclosure are described herein in an automated system and method for comparing insurance quotes and policies and recommending an optimum insurance quote according to a customer profile and insurer's risk to appetite. Those of ordinary skill in the art will realize that the following detailed description of the present disclosure is illustrative only and is not intended to be in any way limiting. Other embodiments of the present disclosure will readily suggest themselves to such skilled persons having the benefit of this disclosure. Reference will now be made in detail to implementations of the present disclosure as illustrated in the accompanying drawings. The same reference indicators will be used throughout the drawings and the following detailed description to refer to the same or like parts.

Reference in the specification to “one embodiment” or “an embodiment” is intended to indicate that a particular feature, structure, or characteristic described in connection with the embodiment is included in at least an embodiment of the disclosure. The appearances of the phrase “in one embodiment” or “an embodiment” in various places in the specification are not necessarily all referring to the same embodiment.

The present disclosure relates to a system and method for comparing a plurality of insurance quotes and associated insurance policies and recommending an optimum insurance coverage according to a customer profile and insurer's risk to appetite. The system and method of the present disclosure are configured to align with customer profiles and risk appetites of insurers, leading to more accurate and personalized insurance recommendations. Such precision reduces financial risks to both insurance companies and the insured, as policies are better tailored to the actual needs and risk profiles involved. The present disclosure provides a side-by-side comparison of insurance quotes and clauses showing similarities and mismatches against quote ask and further summarizes a plurality of quote options and clauses along with recommendations. The present disclosure prevents errors and omissions (E&O) which is prevalent in manual policy checking and quote comparisons, thereby avoiding E&O exposures for insurance agents and brokers, as well as preventing suboptimal coverage or cost for insureds. Further, the present disclosure saves time and effort in policy checking and quote comparisons while ensuring accuracy in policy checking and quote comparisons. Furthermore, the present disclosure identifies inaccuracies in insurance policies and missed features such as premium leakage, missed endorsements and other follow up servicing issues, thereby improving customer experience and lower end customer satisfaction, and reducing coverage gaps. The present disclosure combines use of Large Language Models (LLMs), traditional machine learning techniques, 3rd party insurance industry data and cognitive automation tools to enable hyper automation in comprehending complex insurance quotes and policies with excess and surplus lines especially specialized insurance. The present disclosure analyzes and interprets policy terms and conditions with a level of precision and depth that may surpass the understanding of individual brokers and agents. Therefore, the present disclosure leads to more informed advising for customers. Further, the system and method of the present disclosure streamlines the comparison of subjective elements within insurance quotes, such as inclusions, terms, and exclusions etc. By automating the comparison process, the system and method ensure a thorough and nuanced analysis that might be time-prohibitive for humans to perform, especially when dealing with a high volume of policies. Furthermore, the system and method of the present disclosure provide policy and market insights for the insurers and insurance brokers on trends, errors and learnings on the policies based on historical quote and policy data, thereby enabling the insurers to improve the insurance products or form new insurance products and the insurance brokers to find leads and recommend insurance policies to insured. The system and method of the present disclosure further provide placement insights for insurance brokers, thereby aiding the insurance brokers in selecting coverages, limits and terms and conditions for a type of customer, and in selecting insurance carriers providing such selected coverage. Accordingly, the present disclosure also reduces reliance on wholesalers and almost doubles retained income for the insurance brokers. Additionally, the present disclosure generates a certificate of insurance (COI) by leveraging comparison of an insurance contract with a COI request form, thereby ensuring accuracy and compliance with requested coverage details, reducing manual errors, and streamlining an issuance process. The approach of generation COI automatically enhances operational efficiency, improves response times, and ensures that the COI reflects precise terms and conditions of the underlying insurance policy, minimizing discrepancies and potential disputes.

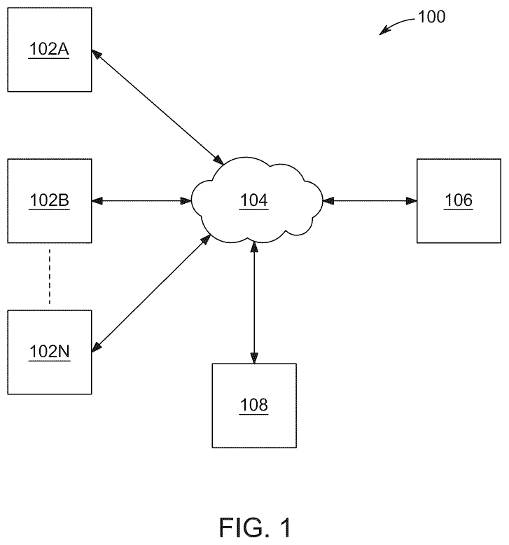

Reference is initially made to FIG. 1, which illustrates a system 100 for comparing insurance documents in accordance with the present disclosure. It is to be noted that an insurance document is a formal record detailing terms, coverage, conditions, and specifics of an insurance policy agreement between an insurer and the insured. Examples of insurance documents include, but not limited to, insurance policies, insurance quotes, certificates of insurance (COI), COI request forms, insurance contracts, claim forms, endorsements, renewal notices, exclusion clauses, a proof of loss, a proof of expense, information about insured item, or combination thereof. An insurance quote refers to an estimate of a premium for an insurance coverage requested. An insurance policy refers to a contract between an insurer (i.e., insurance company) and an insured (i.e., policyholder), which determines the claims in which the insurer is legally required to pay. In exchange for an initial payment, known as the premium, the insurer promises to pay for loss caused by perils covered under the policy language. COI refers to a document that verify an existence and terms of insurance coverage, typically summarizing policy limits, effective dates, and key coverage details. COI request form refers to a form submitted to request the COI, specifying details needed on the COI, such as insured party information, coverage, and policy terms. Insurance contract refers to a legal agreement outlining obligations of an insurer and insured, including coverage details, claim processes, premiums, and applicable conditions or exclusions. Claim form refers to a form filled out by an insured to initiate a claim, providing details of an incident, a loss, or a damage and supporting evidence for the claim. Renewal notice refers to a notification from insurers to policyholders indicating an upcoming policy renewal date, often including revised terms, premium rates, and payment information. Proof of loss refers to a formal statement or document provided by the insured to the insurer after a claimable event (e.g., accident, theft, or damage) has occurred. Proof of expense refers to a documentation provided to demonstrate costs incurred as a result of a claimable event, such as receipts, invoices, or repair bills. Information about insured item refers to details and documentation describing an item or property insured under the policy, including its type, model, condition, value, and unique identifiers (e.g., serial numbers or VINs for vehicles).

The system 100 includes a plurality of user devices 102A-N, a server 106 that is communicatively coupled with the plurality of user devices 102A-N via a network 104. The plurality of user devices 102A-N may be associated with users. The users may be, but not limited to, an insurance agent, an insurance broker, an insured, an insurance company or an insurer, a carrier, underwriters, a reinsurer, financial advisors, any person or any organization which needs to check a plurality of sections of the plurality of insurance documents or any individual entities requiring proof of insurance coverage for verification, legal compliance, or risk management. The organization may be a regulatory body that provides an approval for insurance products after filing with the regulatory body. The plurality of user devices 102A-N herein after referred as a user device 102 throughout the disclosure. The user device 102 may be, but not limited to, a mobile phone, a personal digital assistant (PDA), a tablet, a desktop computer, a laptop, or any computing unit/device having a processing unit to upload the insurance documents and perform one or more functions of the system 100. The network 104 may be, but not limited to, a wired network, a wireless network, or a combination of wired and wireless network. Some examples of the network 104 includes, but not limited to, a local area network (LAN), a wide area network (WAN), a virtual private network (VPN), a mobile network, a peer-to-peer network, a Bluetooth network, a public network, a proprietary network, a public telephone switched network (PSTN), or combination thereof. The server 106 is configured to receive a plurality of insurance documents from the user device 102 via the network 104. The insurance document may be in any format that include, but not limited to, a word format, a pdf format, an image format, a text format, a spreadsheet format and a presentation format. When the insurance documents include at least one of two or more insurance quote documents, corresponding two or more insurance policy documents, or combination thereof, the server 106 is further configured to compare a plurality of insurance quotes and associated insurance policies and recommending an optimum insurance coverage according to a customer profile and insurer's risk to appetite. In some embodiments, when the two or more insurance documents comprise a new insurance policy and at least one of prior year insurance policy, the server 106 is configured to identify at least one of errors and omissions, and any coverage gaps in the new insurance policy over the at least one of prior year insurance policy by leveraging comparison data of the new insurance policy with the prior year insurance policies. In some embodiments, the server 106 is configured to highlight similarities and differences across the two or more insurance quote documents with respect to entities and contents associated with each insurance quote document by understanding the contents of the insurance documents according to the context. In one instance, the server 106 highlights similarities and differences with respect to the entities such as premium, deductibles etc. across the insurance quotes documents. In another instance, the server 106 is configured to highlight similarities and differences across the two or more policy documents with respect to entities and contents associated with each insurance policy document by understanding the contents of the insurance documents according to the context. In some embodiments, the server 106 is configured to compare the plurality of insurance quotes and the associated insurance policies and provide insights on trends, errors and learnings on the insurance policies, coverages, insurance carriers to the user by leveraging analysis and summarization across the plurality of insurance quotes and the associated insurance policies. In one exemplary embodiment, the server 106 is configured to provide insights regarding areas of improvement for each insurance product or a line of business where most of errors are happening based on the comparison of the plurality of insurance quotes and the associated insurance policies. In another exemplary embodiments, the server 106 is configured to provide a pattern of insurance policy or an insurance product selection for a type of insured business. For example, a risk profile to product match trends may be useful for the insurance brokers or the carriers or the insurer or the insurance company. In yet another exemplary embodiment, the server 106 is configured to provide policy wording highlights for carrier product development teams as well as regulatory procedures. In yet another exemplary embodiment, the server 106 is configured to provide endorsement, changes and updates to insurance product documentation and filings or formation of new insurance products based on acceptance and sales of types of insurance policies, packages and customized products by different carriers. In some embodiment, the server 106 is configured to recommend optimum insurance products, and/or insurance carriers/market based on placement insights generated from a plurality of processed historical policy and quote data and the consumer data and automatically obtain the plurality of insurance documents based on the recommended insurance products, insurance carriers/market for comparison, thereby the insurance brokers may not rely on wholesalers and increase their income. The recommended insurance products may include, but not limited to, an insurance coverage, a policy limits, terms and conditions, clauses, that are suitable for a specific type of customer. The recommended insurance carriers may provide or offer recommended insurance products. The insurance broker may ask the insurance carriers for the quote and policy based on the recommended insurance products, and/or insurance carriers/market and then provide the obtained quotes and policies for comparison and summarization. In some embodiments, the server 106 is configured to analyze a loss portfolio transfer (LPT) and perform large loss assessments for the reinsurer. In some embodiments, the server 106 is configured to analyze the plurality of insurance documents to determine whether each insurance document satisfy predefined criteria's of a regulatory body and enable approval of a corresponding insurance product by the a regulatory body. In some embodiments, when the two or more insurance documents comprise the insurance contract and the COI request form, the server 106 is configured to generate a certificate of insurance (COI) by leveraging comparison data of the COI request form and the insurance contract.

The server 106 may be, but not limited to, a local server or a cloud server. In some embodiments, the user device 102 is configured to compare the plurality of insurance quotes and associated insurance policies and recommending an optimum insurance coverage according to the customer profile and insurer's risk to appetite. In some embodiments, the user device 102 may perform all tasks similar to the server 106.

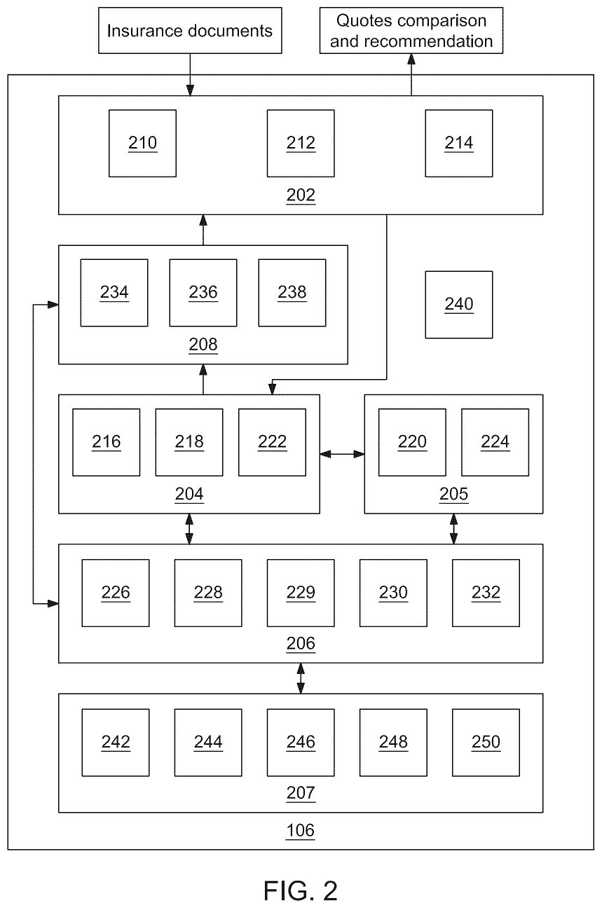

FIG. 2 is a block diagram that illustrates one or more modules of the server 106 of FIG. 1 in accordance with the present disclosure. The server 106 includes a connecting layer 202, a domain layer 205, an analytics layer 204, a large language model (LLM) layer 206, a core logic layer 208, a process automation layer 240, and an insight layer 207. The connecting layer 202 acts as an intermediary layer through which other layers of the server 106 are invoked for comparing the insurance documents. The connecting layer 202 comprises, but not limited to, an application programming interface (API) module 210, a business process as a service module (BPaaS) 212, and software as a service (SaaS) module 214. The connecting layer 202 may further comprise an email connector, a cloud storage connector, and secure file transfer protocol (SFTP) (not shown in FIG. 2). The email connector may be used to automate the communication process when a user registers with the system 100, thereby automatically sending confirmation emails, account activation messages, welcome emails, documents, and alerts and notification. The cloud storage connector may be used to access the cloud storage for accessing and storing any document or service or function. The secure file transfer protocol is used to transfer files or documents or a portion of a document securely across the different system or devices. The domain layer 205 is configured for storing a plurality of libraries including, but not limited to, a clause library 220 and a domain specific prompt library 224. The analytics layer 204 and the LLM layer 206 are configured for comprehending the insurance document details such as quote and policy details for different lines of business and recommending the optimum insurance quote after comparing two or more insurance quotes across a plurality of entities. The insight layer 207 is configured for providing policy and market insights for the carriers, the insurance brokers on trends, errors and learnings on the policies, coverages, premium, etc. The server 106 may include a presentation layer (not shown in FIG. 2). The presentation layer may encompass modules for viewing quotes and policies, examining source documents, managing reports and dashboard and managing work queues.

The analytics layer 204 includes, but not limited to, an entity recognition module 216, a classification, transformation and enhancing (CTE) module 218, and quote and policy models 222. In some embodiments, the analytics layer 204 further comprises an image pre-processing module, and a semantic comparison module (not shown in FIG. 2). The entity recognition module 216 are algorithms that are configured to identify the plurality of entities that are immediately apparent from the two or more insurance documents using the domain specific prompt library 224. The entity recognition module 216 leverages the domain-specific prompt library 224 tailored for the insurance industry, enabling the entity recognition module 216 to recognize key terms and data points unique to the insurance documents. By using the domain-specific prompt library 224, the entity recognition module 216 identifies and categorizes entities such as policy numbers, effective dates, coverage types, limits, deductibles, premiums, and insured parties with high accuracy and relevance. The entity recognition module 216 ensures that the entities are consistently extracted across varied document types, enabling efficient data processing and reducing manual input. In one exemplary embodiment, when processing an insurance policy document and a COI request form, the entity recognition module 216 may identify entities such as Policy Effective Date: “01-01-2024”, Policy Expiration Date: “12-31-2024”, Coverage Type: “General Liability”, Limits: “$1,000,000 per occurrence”, Deductible: “$10,000”, and Premium: “$5,000 annually”. The ML or AI models of the entity recognition module 216 are trained on the domain-specific prompt library 224, thereby identifying the key entities that vary from one line of business to the other easily and with minimal training.

The quote and policy models 222 aid in identifying relationship between fields, clauses and terms across the insurance documents and consolidate the data. As an example, there could be endorsements which modify an existing exclusion in the policy or a definition in the policy. The quote and policy models 222 help in identifying these relationships between the fields. In one example, the quote and policy models 222 may recognize that the standard exclusion of “water damage due to flooding” in the quote has been overridden by an endorsement in the policy. This means that if the property is damaged due to a flood, the insurance policy will not cover the costs of this damage under the standard terms. Although the original quote excluded flood damage, the final policy has been modified to include coverage for this specific type of damage. The quote and policy models 222 may then integrate such information to create an accurate and updated summary of coverage for the insured party, reflecting the true nature of the insurance policy. The classification, transformation and enhancing (CTE) module 218 is configured for performing pre-processing and post-processing of data that is fed to the LLM layer 206 and data that is received from the LLM layer 206 outputs respectively. For example, in pre-processing, the incoming data is classified to identify a right line of business, the type of document, subsection of the document and its related annexures, etc., based on which models of the server 106 will be triggered. During post-processing, data identified is enhanced through lookups, a particular field might have to be transformed to a specific format and so on.

The domain layer 205 comprises the clause library 220 and the domain specific prompt library 224. The clause library 220 comprises a plurality of clauses that are present in insurance policies across a different line of business. The insurance clauses are organized in a hierarchy, from general to specific, and are tailored to different types and insurance products. It is to be understood that the clauses are specific provisions or sections that set out the details of the insurance coverage. Examples of clauses include, but not limited to, a coverage clause, an exclusion clause, a condition clause, an endorsement clause, a deductible clause, and a limitation clause. The clause library 220 enables to identify variations across different lines of business in insurance documents and aid machine learning (ML) or artificial intelligence (AI) models in understanding the quote and policy details that need to be compared. Fields like coverages, exclusions and endorsements vary by lines of business. Examples of different line of business in insurance include, but not limited to, commercial insurance, specialty insurance and personal insurance. The commercial insurance includes, but not limited to, commercial general liability insurance, commercial property insurance, workers' compensation and employers' liability, professional liability, errors and omissions insurance, commercial crime policy, professional liability for directors and officers, commercial auto or business auto, package policies with property and liability, auto liability, business income coverage insurance, and cyber insurance. The specialty insurance may include, but not limited to, inland and ocean marine insurance, aviation insurance, marine cargo insurance, environmental liability insurance, event insurance, and trade credit insurance. The personal insurance may include, but not limited to, automobile insurance, health insurance, life insurance, home insurance, travel insurance. The ML or AI models are trained on the clause library 220, thereby identifying the quote and policy details that vary from one line of business to the other easily and with minimal training.

The clause library 220 comprises a product clause library and a carrier clause library. The product clause library comprises a plurality of clauses specifically tailored to various insurance products. Within the clause library 220, a multitude of clauses that encapsulate the terms, conditions, and provisions associated with distinct insurance offerings exist. Similarly, the carrier clause library comprises a plurality of clauses specific to individual insurance carriers. The carrier clause library is populated with a variety of clauses that outline unique stipulations, requirements, and nuances set forth by different insurance companies. Together, the product clause and carrier clause libraries form a comprehensive collection of clauses essential for constructing and analyzing insurance documents such as policies across a spectrum of products and carriers. The clause library 220 is updated in real time based on the plurality insurance documents received for analysis. The clause library 220 also helps in identifying critical and basic coverages, endorsements or exclusions that are missing from a quote or policy, thereby helping the broker to recommend these to the insured.

The domain specific prompt library 224 includes instructions and/or questions that are tailored to elicit detailed information related to various insurance coverages and products from the insurance documents such as insurance policies and insurance quotes documents. Similar to the clause library 220, the domain specific prompt library 224 includes instructions and/or questions across the different line of business. Some examples of the domain specific prompt library 224 include 1) “what are the coverages insured under this policy?, 2) What are the exclusions listed in this policy, 3) What is the deductible amount for this policy, and how does it affect the premium?, 4) What is the effective date and the expiration date of this policy?, 5) Are there any endorsements that alter the standard coverage?etc.

The image preprocessing module may be configured to preprocess the insurance documents if it is in the image format for converting into a standard format which is readable by the layers of the server 106. The semantic comparison module may be configured to understand the context of the insurance documents.

The LLM layer 206 includes a contextual extraction module 226, an augmentation module 228, a contextualizing and summarizing module 229, a comparison module 232, a summarization module 230, and a COI generating module 232. The contextual extraction module 226 is configured to contextualize and extract the plurality of entities that are not be immediately apparent in the two or more insurance documents by leveraging relationship determined by the quote and policy models 222. The contextual extraction module 226 applies advanced algorithms to analyze contextual cues, dependencies, and inferred connections between entities that may not be explicitly stated. By understanding relationships between fields across documents-such as between a quote and the finalized policy, the contextual extraction module 226 may deduce missing or implied entities, ensuring a more comprehensive extraction. For example, the contextual extraction module 226 is created to handle specific scenarios such as identifying the endorsement to which a limit or deductible applies. Another example where this helps is to identify the value of fields which are embedded in policy clauses (e.g., prior/pending litigation date for errors & omissions policy). In another example, suppose there's a quote document that lists a “Discount Percentage” for a policy, but an actual policy document doesn't explicitly mention a final premium after applying the discount. The contextual extraction module 226 would recognize the connection between the “Discount Percentage” in the quote and the “Total Premium” in the policy. Using the relationship mapped by the quote and policy models 222, the contextual extraction module 226 calculates or infers a discounted premium amount, even if a specific figure isn't directly stated in either document.

The augmentation module 228 is configured to augment the plurality of entities with third party data sources 108 which help in validating and completing the data. The contextualizing and summarizing module 229 is configured to understand the context of the contents of the insurance documents such as policy language, using the clause library 220 as well as the domain specific prompt library 224 based on which a plurality of clauses that includes, but not limited to, coverages, exclusions, endorsements and other terms and conditions may be identified. The contextualizing and summarizing module 229 is advantageous that the module 229 understands the contents across the two or more insurance documents even the content written in a different way or format. By understanding differently phrased content, the contextualizing and summarizing module 229 can accurately identify equivalent terms or clauses, even if written in varying styles or structures. This ensures comprehensive comparisons between documents. Imagine an insurance quote document includes a section on “medical expenses covered up to $50,000,” while the corresponding policy document uses the phrase “maximum health coverage capped at $50,000 per claim.” Despite the different phrasing, the contextualizing and summarizing module 229 would recognize these as equivalent and match them. Further, if the policy document includes an additional clause on “dental expenses limited to $10,000” not mentioned in the quote, the contextualizing and summarizing module 229 could flag this difference, ensuring that both documents align before a decision is made. Let's imagine, Policy A includes a clause for “accidental death coverage up to $100,000,” while Policy B states “accidental death benefit of $120,000.” Despite the similar intent, these policies have a variation in coverage amount, and the contextualizing and summarizing module 229 would flag this difference, allowing the client to weigh the financial implications of each option. Additionally, if Policy A contains a specific exclusion for “natural disasters,” while Policy B lacks any mention of natural disasters in its exclusions, the contextualizing and summarizing module 229 would identify this discrepancy. The comparison module 232 is trained and configured to compare the plurality of augmented entities and the plurality of clauses such as exclusion, endorsement and coverage clauses across the plurality of insurance documents from a same carrier or from different insurance carriers and identify the differences and similarities. This is not a word-by-word comparison; the comparison module 232 leverages the contextual understanding of the line of business to compare the clauses and identify the matches and differences. The comparison module 232 may comprise an entity comparison module and a clause comparison module. It is to be noted that a single module may compare identified entities and clauses. The compared data is then summarized using the summarization module 230. The summarization module 230 does a document level as well as a comparison summarization thereby generating a textual summary for the user such as the insurance broker or agent. The LLM layer 206 may further comprise a prompt orchestration module and a configurable LLM module. The prompt orchestration module may be configured to orchestrate or manage the use and sequence of domain specific prompts. The configurable LLM module is configured to enable the use of different large language models according to specific needs or preferences.

The LLM layer 206 further includes a context filtering module (not shown) that is configured to identify or filter one or more pages of each insurance document comprising at least one of a quote data, a policy data, or an insurance contract data, a COI request data, or combination thereof. The context filtering uses natural language processing techniques to scan each document, and isolating pages that hold essential information, such as coverage details, limits, deductibles, policy terms, and contract provisions. By filtering for relevance, the context filtering module streamlines document processing, passing only critical content to downstream analytical models, which enhances both processing efficiency and extraction accuracy.

The core logic layer 208 includes a scoring module 234, a prioritization module 236, and a recommendation module 238. The scoring module 234 is configured to create a scoring for the output of the models. The score includes an accuracy score indicating the accuracy of the extracted information across the documents, and an automation score indicating level of automation achieved in identifying, extracting, comparing and summarizing the data across the documents. The scores are calculated based on the accuracy, the matches and mismatches during the comparison and the summarization accuracy. The prioritization module 236 is configured to prioritize in choosing the response for the different fields as the extracted data is being validated and augmented witty external data sources. When there are values from multiple sources for the same field, this helps in determining the right value. The recommendation module 238 is configured for creating recommendation of quotes or other recommendations by leveraging summarization done by LLM layer 206 and a level of matches and differences across the documents. This is used to indicate to the user/customer which quote is recommended along with the underlying analysis. Further, the process automation layer 240 is configured to automate highly repetitive and routine tasks.

The COI generating module 233 is configured to generate is configured to generate COI that reflect the specific coverage details, limits, and terms as required by stakeholders by leveraging comparison of the insurance contract and the COI request. The COI generating module 233 pulls relevant information from the insurance contract, such as policy numbers, effective dates, coverage types, limits, and endorsements, and formats the relevant information into a COI template to generate the COI.

The insight layer 207 includes, but is not limited to, a portfolio analysis module 242, a coverage trend analysis module 244, a pricing trend analysis module 246, a carrier insight providing module 248, and a variance analysis 250. The portfolio analysis module 242 is configured to assess and analyze the plurality of insurance quotes and associated insurance policies across different lines of business and carriers for a broker. The analysis may include considerations such as types of coverage, risk profiles, geographic distribution, and other relevant factors. The portfolio analysis module 242 aims to provide a comprehensive understanding of the collective insurance holdings. The coverage trend analysis module 244 is configured to track and analyze trends related to insurance coverage over time by analyzing the types of coverage offered, policy limits, deductibles, and other coverage-related factors change or evolve. The coverage trend analysis module 244 provides insights into dynamics of coverage preferences and helps stakeholders understand shifts in the market or within the organization's offerings. The pricing trend analysis module 246 is configured to evaluate trends in insurance pricing by analyzing changes in premium rates, factors influencing pricing adjustments, and market trends impacting the cost of insurance. Such analysis helps insurers, brokers, or organizations stay informed about pricing dynamics and make data-driven decisions related to pricing strategies. The carrier insight providing module 248 is configured to provide insights and information related to insurance carriers that may include, but not limited to, performance, reliability, financial stability, and market reputation of various insurance carriers. The carrier insight providing module 248 assists users in making informed decisions when selecting or partnering with insurance carriers based on comprehensive insights. The variance analysis 250 is configured to compare projected or expected results, such as premium revenue or claims costs, with the actual results. Understanding variances helps identify areas of success or areas that may require attention and corrective action.

In some embodiments, the server 106 further includes a verification module, an insurance coverage recommendation module, and validating module, an editing module, an audit module, and a lead finding module (not shown). The verification module is configured for checking and verifying completeness and accuracy of data in an insurance submission based on past insurance policies, submissions to insurance agents and companies, and third-party data sources 108. For example, if a customer applies for a home insurance, the verification module ensures whether all required fields are filled, such as property age, construction material, and security features, cross-verifies the submitted information, like the property address etc., against past insurance policies, insurance submissions to insurance agents and companies, and the third-party data sources 108. While cross verifying, the verification module reviews customer's past insurance history to identify any discrepancies, such as whether previous claims disclosed or not in the current submission, examines the insurance submissions that customer may have made to other insurance agents or companies for consistency and. Utilizes the third-party data sources 108, like credit reports and crime databases, to assess customer's financial stability and potential risk factors associated with the property's location. The thorough analysis ensures to accurately evaluates the risk and coverage requirements for customer's policy.

The insurance coverage recommendation module is configured to recommend an optimum insurance coverage that an insured to apply based on their North American Industry Classification System (NAICS) code or standard industrial classification (SIC) code, revenue and other business profile, state or jurisdiction of operations and line of business. In one exemplary embodiment, if someone looking for an insurance coverage for his/her software company that has a revenue of $5 million annually, located in Texas, USA and developing software's for healthcare sector, the insurance coverage recommendation module may recommend a combination of insurance coverages like professional liability insurance, cyber liability insurance, general liability insurance, and property insurance. The professional liability insurance is recommended to protect against claims of errors, omissions, or negligence in their software services which is particularly important in the healthcare sector where errors can have significant consequences. The cyber liability insurance is also recommended which is essential for a software company to protect against data breaches. In addition, the general liability insurance is recommended to cover general business risks, including bodily injury or property damage. Similarly, the property insurance is also recommended to protect physical assets like an office space and hardware.

The editing module is configured to document decisions or subjectivities based on comparison of the different insurance quotes and/or policies to trigger actions for the insurance brokers or agents to pursue business closure. Accordingly, the insurance agents or brokers may use the editing module's decisions to effectively communicate the benefits of insurance policies to the customer, addressing their specific concerns and requirements. Such targeted approach, backed by thorough comparison and documentation, helps in successfully closing the deal, ensuring the customer gets the best-suited insurance policy. The audit module is configured to track gaps identified, errors captured and corrected with date and time stamps. Accordingly, the audit module carries a trail of all the assigned work, approvals, narratives in a single document across insureds. This helps improve compliance and discipline across teams. The lead finding module is configured to obtain and provide a list of businesses in a defined territory that match certain risk profiles, demographic and firmographic parameters for the purposes of insurance marketing.

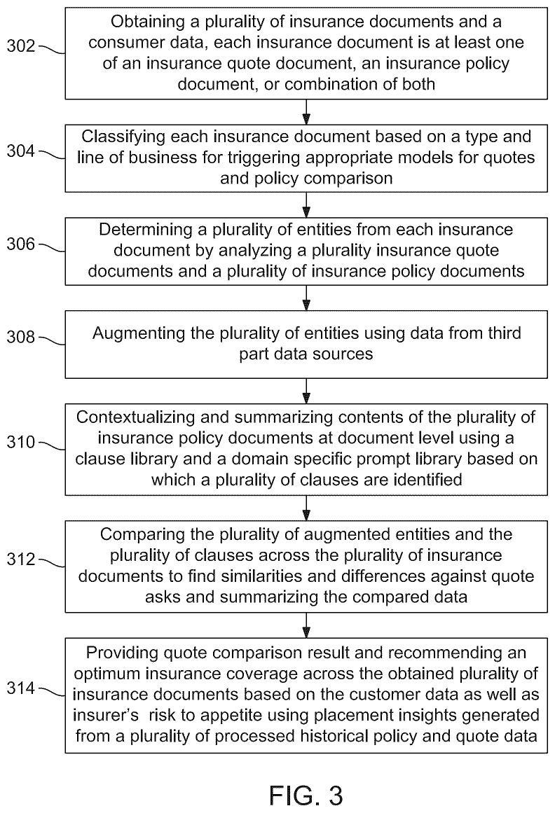

According to the disclosure, all the elements described above contribute to enable the implementation of a method for comparing insurance quotes and policies and recommending an optimum insurance quote, as described below in connection with FIGS. 3-9C. FIG. 3 is a flowchart that illustrates a method for comparing insurance documents in accordance with the present disclosure. At step 302, a plurality of insurance documents and consumer data are obtained. Each insurance document is at least one of insurance policies, insurance quotes, certificates of insurance (COI), COI request forms, insurance contracts, claim forms, endorsements, renewal notices, exclusion clauses, a proof of loss, a proof of expense, information about insured item, or combination thereof. The plurality of insurance documents may be obtained from a plurality of insurance carriers or insurance companies. In some embodiments, the plurality of insurance documents is obtained from a same insurance carrier or insurance company. It is to be noted that each insurance document may or may not differ in terms of quotes, clauses, and terms and conditions and the like. Each insurance quote document comprises initial estimates provided by different insurance companies, detailing coverage terms and costs for an insurance product. Each insurance policy document may comprise terms of coverage, exclusions, premiums, and other contractual details. The consumer data may comprise, but not limited to, personal information, property information, previous insurance history and the like. In one exemplary embodiment, the method comprises obtaining two or more insurance quote documents and/or two or more corresponding insurance policies. In another exemplary embodiment, the method comprises obtaining two or more insurance policies and/or two or more prior year insurance policies. In yet another exemplary embodiment, the method comprises obtaining at least one COI request form and a corresponding insurance contract.

At step 304, each insurance document is classified, using the classification, transformation and enhancing (CTE) module 218, based on a type and line of business and filtered relevant pages for triggering appropriate models for comparison. The classification, transformation and enhancing (CTE) module 218 use one or more classification models that are trained on a plurality of clauses across a plurality of line of business. The classification, transformation and enhancing (CTE) module 218 classifies each insurance document to a specific type and the line of business by analyzing sections, subsections, and annexures of each insurance document. It is to be noted that the appropriate models refer to models configured to process insurance documents according to their document type and a line of business the document associated with. The type of the insurance document may include, but not limited to, insurance policies, certificates of insurance (COIs), endorsements, claims forms, quotes, renewal notices, applications, declarations pages, and exclusion clauses. Each type serves a distinct purpose within the insurance process. The line of business of the insurance document includes, but not limited to, general liability insurance, professional liability insurance, property insurance, workers' compensation insurance, automobile insurance, health insurance, life insurance, and marine insurance. Each line of business represents a specific area of risk coverage, catering to different industry needs and regulatory requirements. For example, the classification, transformation and enhancing (CTE) module 218 classifies an insurance document A under general liability insurance after analyzing the sections, subsections, and annexures of insurance document A. Further, the categorizes the insurance document A as a policy document. After categorizing the insurance documents, appropriates models for further analysis of the insurance documents are triggered. For example, if the obtained insurance documents are classified under auto insurance, the models corresponding to auto insurance are triggered or activated for further analysis. If the obtained insurance documents are classified under commercial property insurance, then models corresponding to the commercial property insurance are triggered or activated for further analysis.

At step 306, a plurality of entities from each insurance document are determined by analyzing the identified or filtered pages of the two or more insurance documents by utilizing one or more models of the analytic layer 204 and the LLM layer 206. The contextual extraction 226, the entity recognition module 216, and the quote and policy models 222 work together in a sophisticated manner to analyze, interpret each insurance document, and determine the plurality of entities. The plurality of entities includes, but not limited to, a name of an insured, an address of the insured, a policy number, a name of a carrier, a location schedule, an agency name and address, terrorism, limits, premium, dates, deductibles, exclusions, endorsements, coverage types, a name of COI requester name, an address of COI requester, a name of COI holder, an address of COI holder, a project information, or combination thereof. In some embodiments, the entity recognition module 216 identifies the plurality of entities from the plurality of insurance documents using the domain specific prompt library 224. Thereafter, the extraction module 226 delves deeper than the basic entity recognition and extracts specific data and language from the insurance documents, particularly in complex or unique scenarios. For example, the extraction module 226 may decipher values of fields that are not explicitly stated but are embedded within policy clauses (like the Prior/Pending Litigation Date in an Errors & Omissions Policy). While the entity recognition module 216 locates key data points, the extraction module 226 contextualizes and extracts nuanced information that may not be immediately apparent. The quote and policy models 222 may use the information identified by the entity recognition module 226 and further analyzed by the extraction module 216 to build a comprehensive understanding of the insurance document. This includes understanding the implications of certain terms and how modifications (like endorsements) affect the overall policy. The quote and policy models 222 are essential in understanding how different parts of a document relate to each other. For example, the entity recognition module 216 identifies that an insurance policy has a specific deductible and coverage limit. The extraction module 226 analyzes the context of such entities, such as determining if there are any special conditions or endorsements attached to these limits and deductibles. The quote and policy models 222 consider this information and analyze how these endorsements or conditions affect the overall policy structure, comparing it with similar fields in related quote documents. In some embodiment, the plurality of entities are determined by analyzing the insurance quotes documents and/or associated policies. In some embodiments, the plurality of entities are determined by analyzing the two or more new insurance policies and prior year insurance policies. In some embodiments, the plurality of entities are determined by analyzing the COI request form and the insurance contract.

At step 308, the plurality of entities are augmented using data from third party data sources 108, thereby validating and enhancing the completeness and accuracy of the data of the plurality of entities. The augmentation module 228 is configured for augmenting the plurality of entities. Let's consider a policy renewal for a commercial property. The entity recognition module 216, the extraction module 226, and the quote and policy models 222 coordinatively extracts the policy's effective date, expiration date, coverage limits, deductible, and premium from the renewal document. Thereafter, the augmentation module 228 cross verifies policy's effective and expiration dates with a third-party database that tracks commercial property insurance renewals to confirm their accuracy and to ensure there are no gaps in coverage. Further, the augmentation module 228 may check coverage limits and deductibles against a database that aggregates standard commercial property insurance terms, confirming that they are appropriate for the property's value and risk profile. Similarly, the augmentation module 228 may compare to current market data for similar properties in the same geographical area to verify that the rate is competitive and fair. Such augmented approach ensures comprehensive, accurate, and up-to-date policy terms, which is crucial for effective risk management and customer service. In some embodiments, the classification, transformation and enhancing (CTE) module 218 transforms the plurality of entities from one format to a standard format which is prevalent across the insurance industry for further processing such as augmentation, comparison, and the like.

At step 310, language or contents of the plurality insurance documents are contextualized and summarized using the clause library 220 and the domain specific prompt library 224. The contextualizing and summarizing module 229 is configured to understand the context of the language or contents of the insurance documents using the clause library 220 and the domain specific prompt library 224 based on which a plurality of clauses that includes, but not limited to, coverages, exclusions, endorsements and other terms and conditions may be identified and summarizing the context of the policy language of the plurality insurance policies at document level. For example, each insurance quote is analyzed, and relevant clauses from the clause library 220 are used to interpret and understand the context of the plurality clauses in the plurality of insurance policies. For instance, a clause about cyber liability coverage is used to explain and compare this aspect across different quotes. In another example, policy documents are analyzed to interpret the context of the clauses. In yet another example, COI request form and insurance contracts are analyzed to interpret the clauses, coverages, limits, deductibles etc.

At step 312, the plurality of augmented entities and the plurality of clauses are compared using the comparison module 232 across the plurality of insurance documents to find similarities and differences across the insurance documents. For example, the comparison highlights key differences and similarities between the quotes, policies, such as variations in deductibles, coverage limits, and any unique conditions or exclusions. At step 314, a side-by-side comparison of the plurality of augmented entities and the plurality of clauses across the two or more insurance documents based on comparison of the two or more insurance documents. Further, the compared data is summarized using the summarization module 230. The summarization module 230 creates a summarized report based on the compared data encompassing comparison between quotes, clauses, terms, and conditions across the plurality of insurance documents, and presents summary for each quote option in a streamlined and comparable format. The comparison result and insurance recommendation are provided on a user interface thereby enabling the customer or the insurance agents or brokers to quickly notice, similarities and differences, errors & omissions, view findings and narrative for action required on policies or quotes. In some embodiments, an optimum insurance coverage or quote from the plurality of insurance documents with quotes and policies is recommended using the recommendation module 238 based on the customer data as well as insurer's risk to appetite based on placement insights generated over time for similar insured, risks and coverages. For example, if a company A has a fleet of 50 delivery vehicles and the company's drivers have varying levels of experience, with a generally good driving record and operates in urban and suburban areas, with high traffic volumes and associated risks. Further, insurer A is known for competitive rates for fleets with good driving records but is risk-averse to high-traffic operations. Insurer B specializes in covering businesses operating in high-risk areas but at higher premiums. Insurer C offers balanced coverage with incentives for companies that invest in driver safety training. While providing recommendation, the recommendation module 238 considers the company A's fleet size, operational areas, and driving records and evaluates the insurer's risk appetite against company's risk profile to determine the best fit. Insurer A may offer the lowest premiums but might not provide adequate coverage for high-traffic operations. Insurer B might cover high-risk operations but at a cost that doesn't align with company A's budget. Insurer C, while not the cheapest, may offer the best balance between coverage and cost, especially if company A invests in additional driver training.

In some embodiments, the plurality of insurance policies are checked against prior year insurance policies, new business or renewal submissions, and quote requests by leveraging comparison data of the insurance policies to identify errors and omissions, and any coverage gaps (in terms of coverage, conditions, exclusions, premiums, covered items etc.). For example, such policy checking process reveals that a new policy has a lower coverage limit for property damage, does not adequately cover the increased cyber liability risks, and misses business interruption insurance. In further embodiments, the server 106 triggers a communication with insurance companies to revise the quote offering and/or policies based on how it matches with the quote ask after identifying errors and omissions in the insurance documents and receive revised insurance documents from the insurance companies which are then utilized for quotes comparison. This revised insurance documents are considered as new insurance quotes/policies and the steps as required for summarization and variance check against quote ask are performed.

In some embodiments, the COI is generated by leveraging comparison data of the insurance contract and the COI request form.

In some embodiments, the method further comprises comparing the plurality of insurance quotes and the associated insurance policies by leveraging analysis and summarization across the plurality of insurance quotes and the associated insurance policies over a period of time and generates insights on trends, errors and learnings on the insurance policies using the insight layer 207. In one exemplary embodiment, the method provides insights regarding areas of improvement for each insurance product or a line of business where most of errors are happening based on the comparison of the plurality of insurance quotes and the associated insurance policies. In another exemplary embodiments, the method provides a pattern of insurance policy or insurance product selection for a type of insured business. In yet another exemplary embodiment, the method provides policy wording highlights for carrier product development teams as well as regulatory procedures. In yet another exemplary embodiment, the method provides endorsement, changes and updates to insurance product documentation and filings or formation of new insurance products based on acceptance and sales of types of insurance policies, packages and customized products by different carriers.

In some embodiments, the method further comprises recommending optimum insurance products, and/or insurance carriers/market based on placement insights generated from a plurality of processed historical policy and quote data and the consumer data. It is to be noted that the placement insights may include patterns, trends, and optimal insurance solutions based on past information. The recommended insurance products may include, but not limited to, an insurance coverage, a policy limits, terms and conditions, clauses, that are suitable for a specific type of customer. The recommended insurance carriers may provide or offer recommended insurance products. Thereafter, the method may obtain the plurality of insurance documents based on the recommended insurance products, and/or insurance carriers/market for comparison and recommending optimum insurance coverage. Let's consider an example in the context of the technology industry, specifically for a software development company. The method involves recommending insurance products, and/or insurance carriers/market based on processed historical policy and quote data and consumer information for a company in this sector. In one exemplary embodiment, the method generates placement insights by analyzing of historical policy and quote data for software development companies where the placement insights discloses that the software development companies often face risks related to intellectual property, data breaches, and business interruption and consumer data and purchased insurance coverage for aforesaid risks. Then, the method provides recommendation of insurance products, and/or insurance carriers/market tailored to software development companies including cyber liability coverage, intellectual property insurance, and business interruption insurance. The method may further automatically obtain insurance documents based on recommendations from various carriers. For example: Carrier A provides a comprehensive cyber liability policy with specific coverage for software vulnerabilities. Carrier B specializes in intellectual property insurance and offers customization options for software patents. Carrier C offers business interruption insurance tailored to technology companies, accounting for potential income loss due to system failures. The method may further compare the obtained data to recommend the optimum insurance coverage.

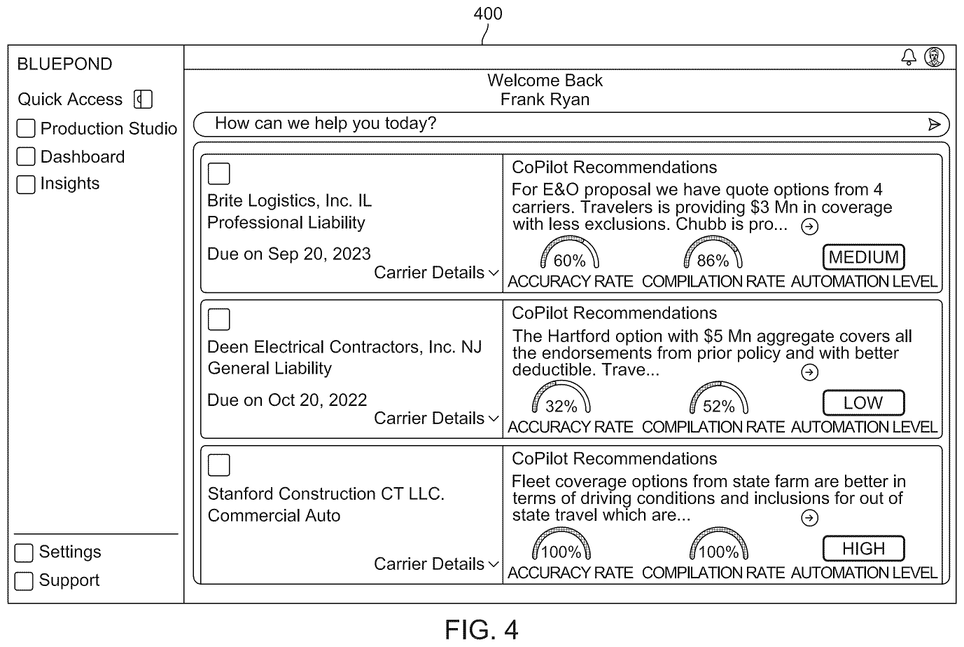

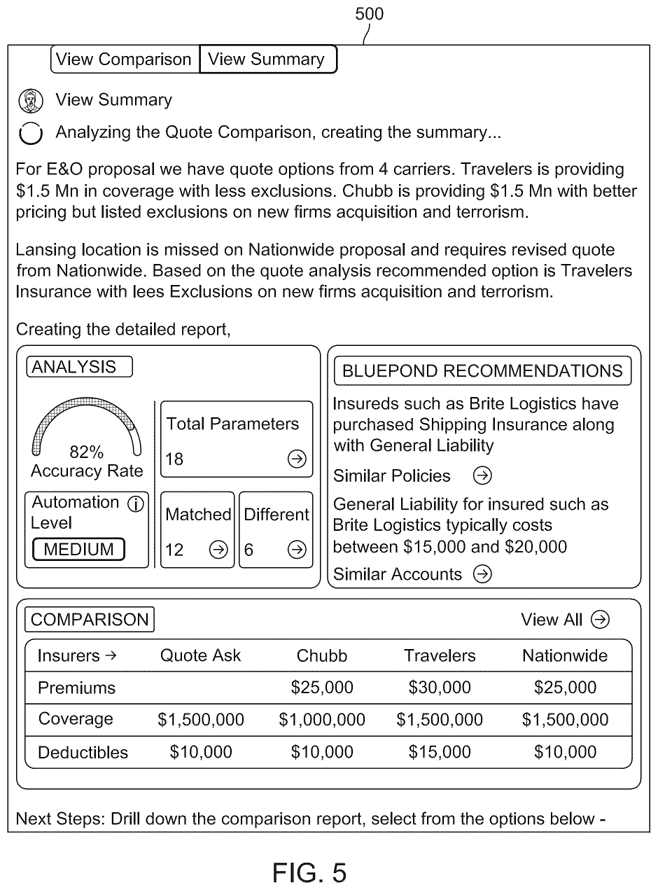

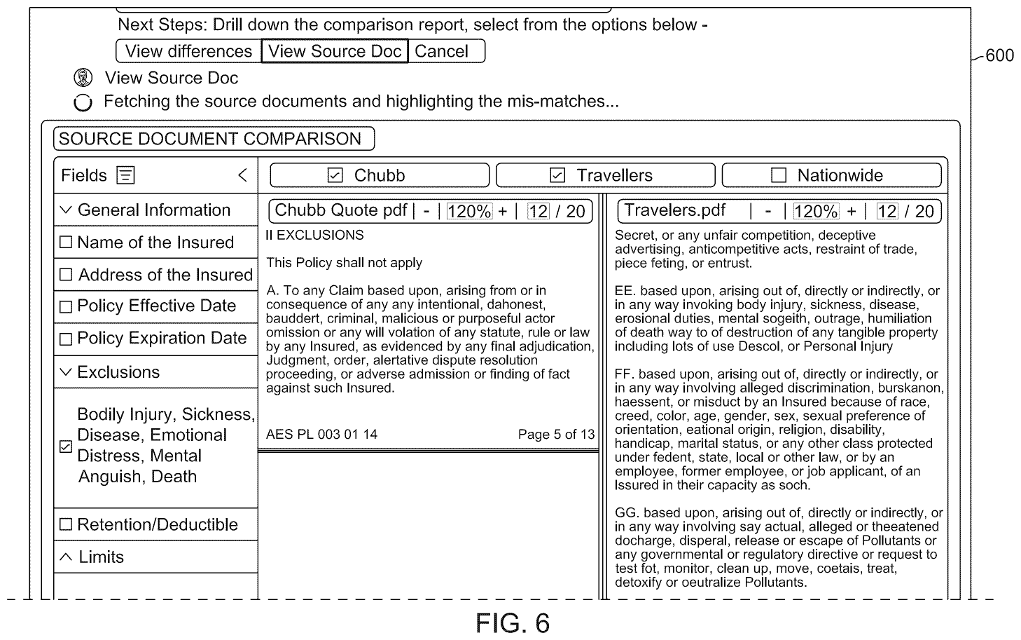

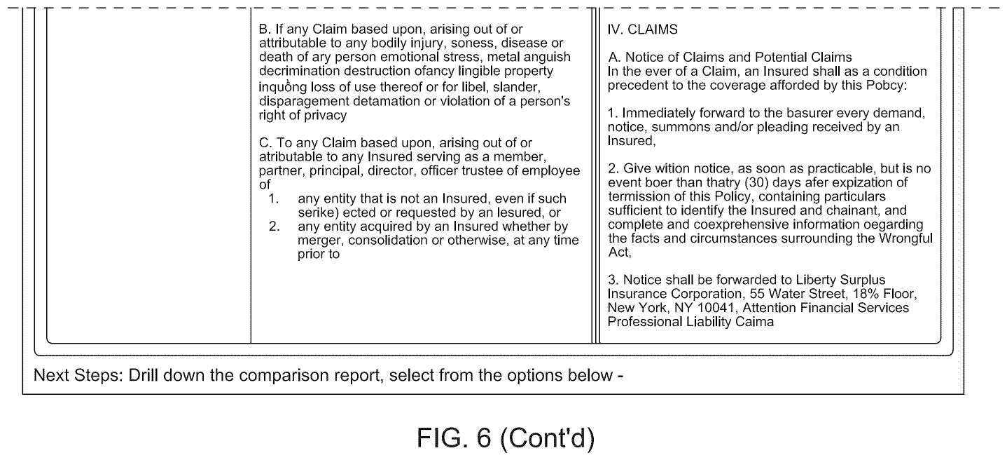

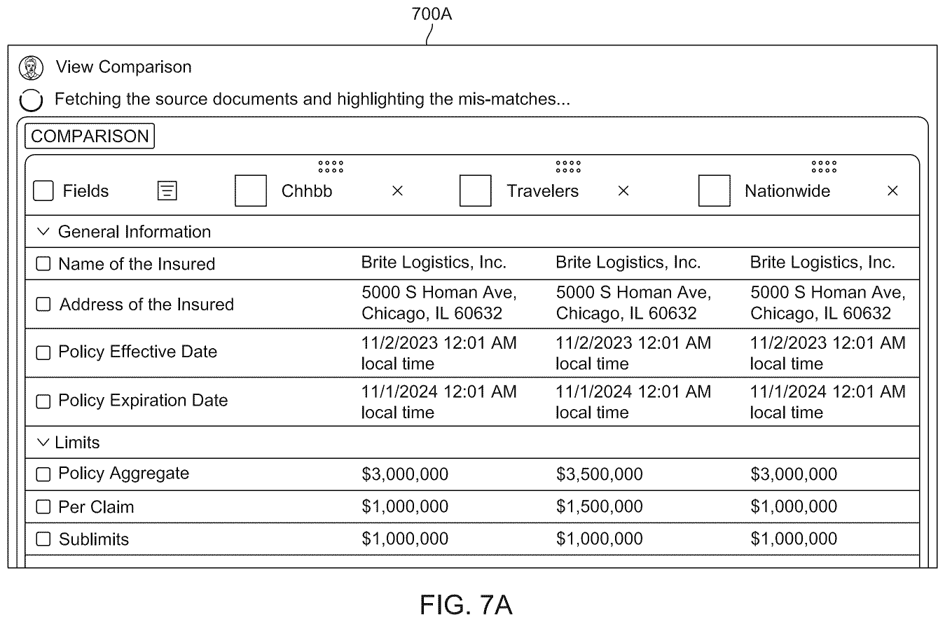

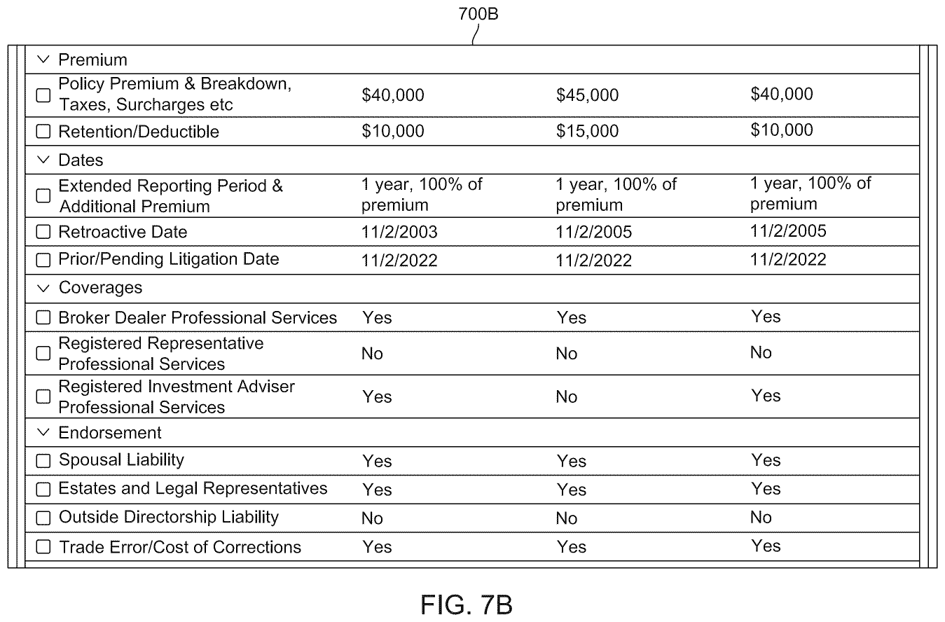

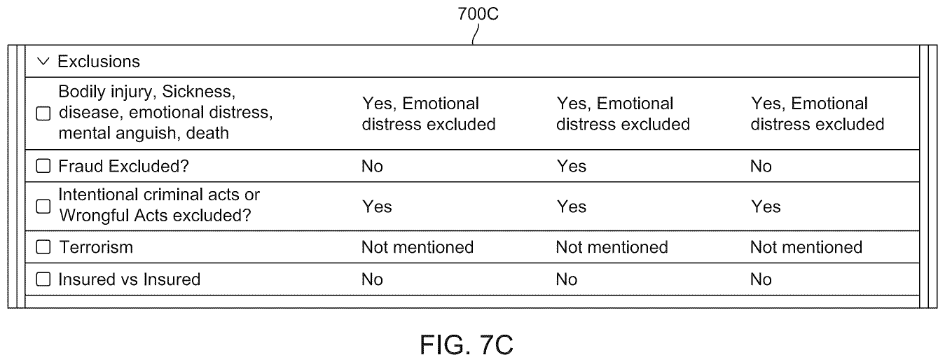

FIG. 4 is a schematic diagram of a user interface 400 that displays a comparison results of insurance quotes for a plurality of customers in accordance with the present disclosure. FIG. 5 is a schematic diagram of a user interface 500 that displays summary, automation score, no. of parameters that are matching and mismatching, quotes recommendation, and quotes comparison for a first customer in accordance with the present disclosure. The summary for each quote comparison is provided. Further, below the summary, the automation and accuracy scores, no. of parameters that are matching and mismatching are provided. Further, insurance recommendation is also given. Thereafter, comparison of the two or more insurance quotes against quote ask are displayed. It is to be noted that there might be a plurality of options to view comparison details. As shown in FIG. 6, the user interface 600 displays a source document (e.g., policy document) highlighting mismatches upon clicking source view source document that highlights the difference between one quote and/or policy document and another quote and/or policy document across different entities such as variation in terms of premium, coverage, limits, deductibles etc. In some embodiments, the color coding is utilized to highlight differences and similarities. FIGS. 7A-7C are schematic diagrams of a user interface 700A-700C that display a comparison of quotes across a plurality of entities in accordance with the present disclosure. As shown in the FIGS. 7A-7C, the user interface 600 displays detailed comparison of the insurance quotes across the plurality of entities upon clicking the view comparison option.

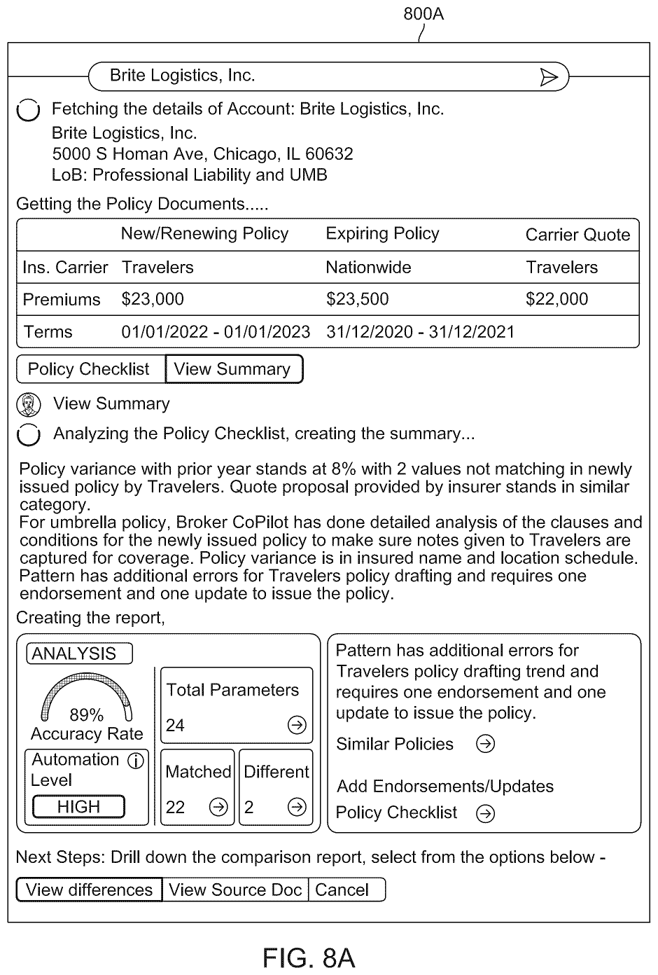

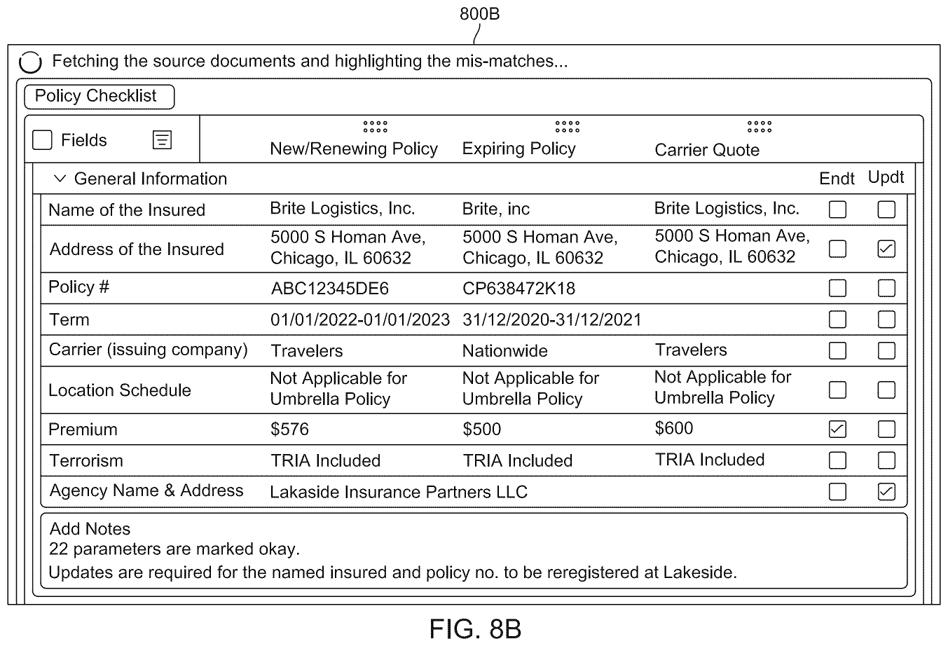

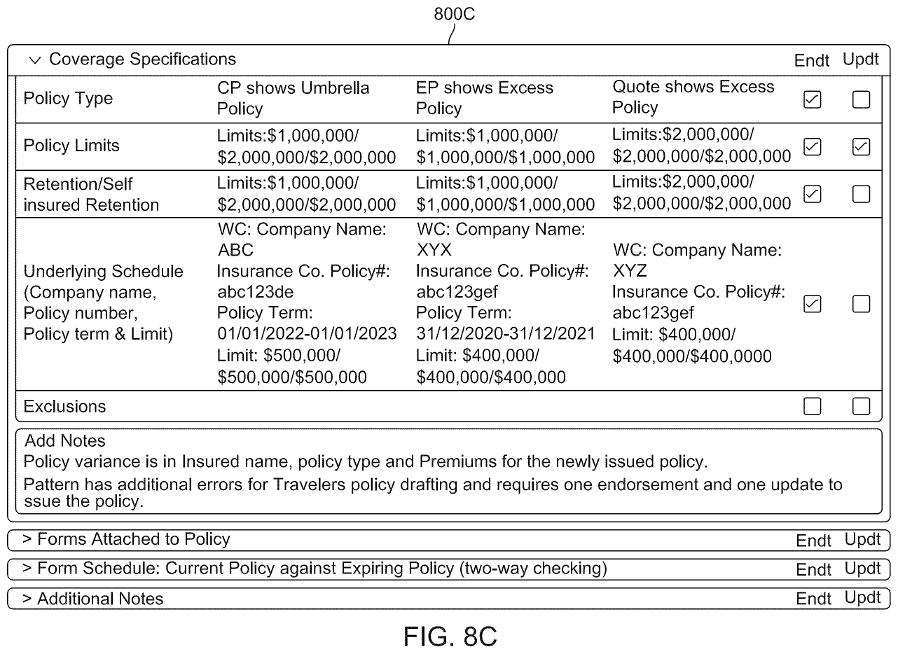

FIGS. 8A-8C are schematic diagrams of exemplary user interfaces 800A-800C that display a summary and comparison of new or renewing policy and associated quote with existing policies in accordance with the present disclosure. Each new or renewal insurance policies are checked against prior year insurance policies, and quote requests to identify errors and omissions, and identify any coverage gaps (in terms of coverage, conditions, exclusions, premiums, covered items etc.). For example, the plurality of fields or entities in the new or renewal insurance policies are compared with prior year insurance policies. The plurality of fields or entities may include, but not limited to, name of the insured, address of the insured, policy number, term, carrier, location schedule, premium, terrorism, agency name and address, policy type, policy limits, retention, underlying schedules, and exclusions (seen e.g., in FIGS. 8A-8C).

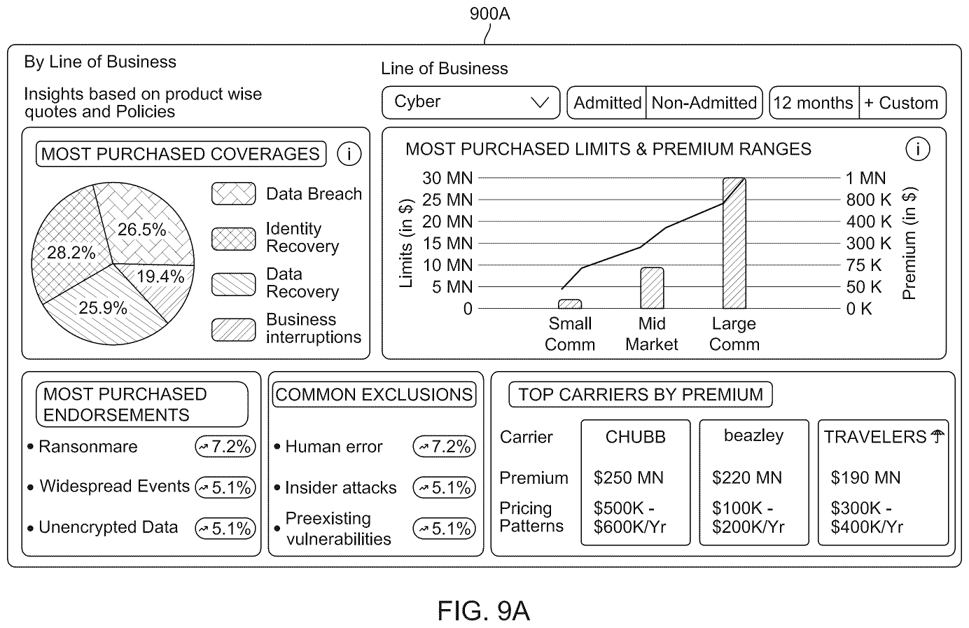

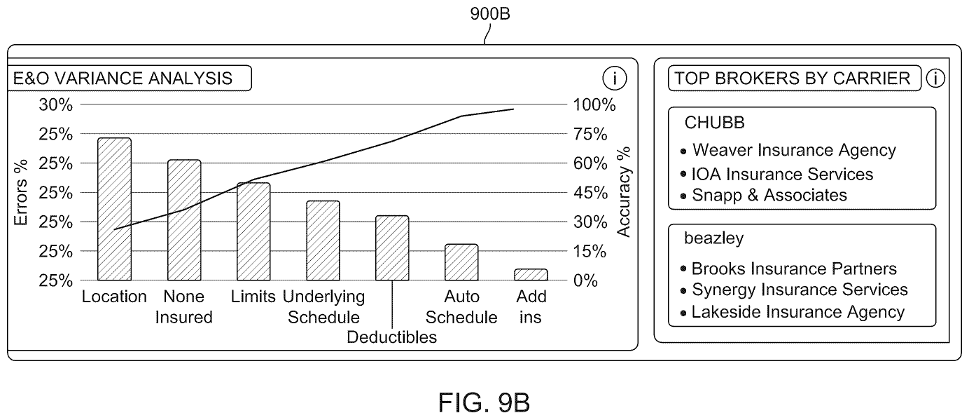

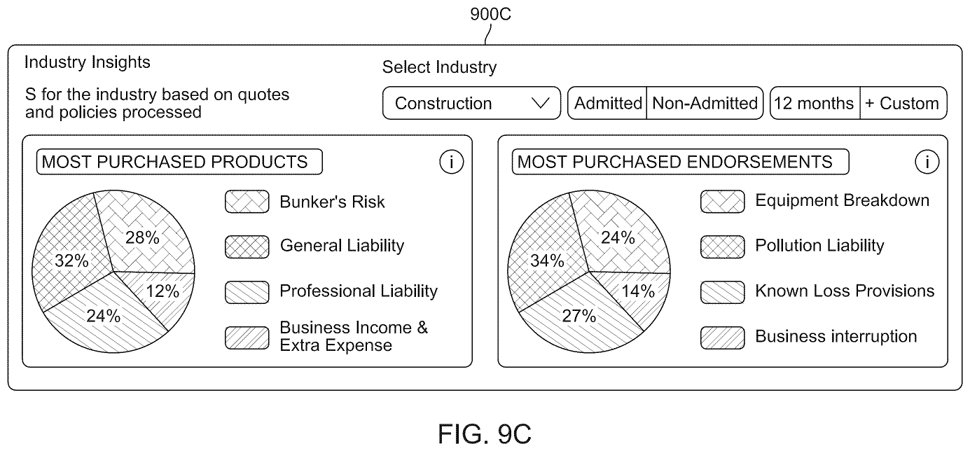

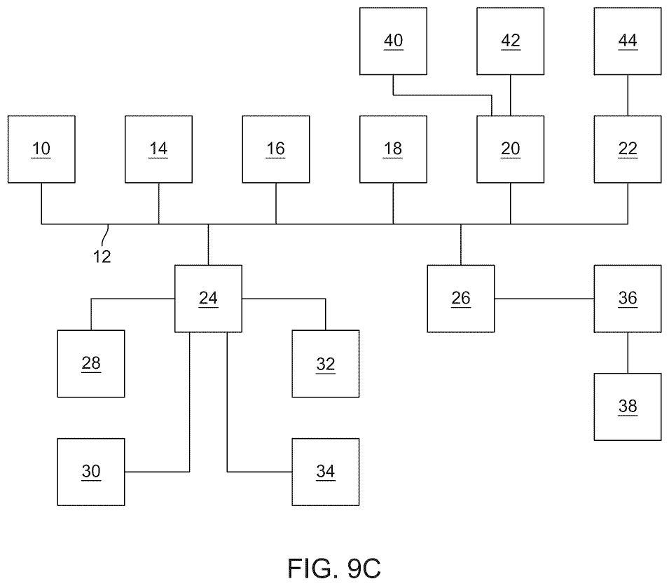

FIGS. 9A-9C are schematic diagrams of exemplary user interfaces 900A-900C that display trends or patterns and insights regarding insurance products and carriers according to a line of business in accordance with the present disclosure. The system and method of the present disclosure compares the plurality of insurance policies and quotes and determines trends or patterns of purchasing of coverages, limits, premium ranges, and endorsements, purchasing of insurance products, common exclusions, top carriers by premium, top brokers by carrier according to a line of business. Accordingly, the present disclosure advantageous to identify most purchased coverages, limits, premium ranges, and endorsements, most purchased insurance products, and identify outcome of purchased products versus projected results. Further, the present disclosure provides E&O analysis, thereby enabling to improve accuracy, reliability, and overall quality of insurance products and services. In other words, the system and method of the present disclosure provides, but not limited to, policy insights and market insights. The policy insights include, but not limited to, trends or patterns of purchasing of coverages, limits, premium ranges, and endorsements, purchasing of insurance products, and common exclusions. The market insights may include, but not limited to, top carriers by premium, and top brokers by carrier, E&O analysis for carriers, common coverage preferences. As shown in FIGS. 9A-9B, if a user (e.g., insurance broker) selects a line of business (e.g., cyber) to which the user wants to know recent trends related to insurance products and carriers, the system 100 generates a user interface 900A-900B that display (i) most purchased coverages; (ii) most purchased endorsements; (iii) common exclusions; (iv) most purchased limits and premium; (v) top carriers by premium, (vi) E&O variance analysis; and (vii) top brokers by carrier. For example, the most purchased coverages may include data breach coverage, identity recovery coverage, data recovery coverage, and business interruption coverage. The most purchased endorsements may include ransonmare endorsement, widespread events endorsement, and encrypted data endorsement. The common exclusions may include human error, insider attacks, and preexisting vulnerabilities. As shown in FIG. 9C, the user selects construction as the line of business, the system 100 generates a user interface 900C to display the most purchased product and endorsement.

A representative hardware environment 800 for practicing the embodiments herein is depicted in FIG. 10, with reference to FIGS. 1 through 9C. This schematic drawing illustrates a hardware configuration of a server/computer system/computing device in accordance with the embodiments herein. The server 106 comprises at least one processing device 10. The special-purpose CPUs 14 are interconnected via system bus 12 to various devices such as a random access memory (RAM) 16, read-only memory (ROM) 18, and an input/output (I/O) adapter 20. The I/O adapter 20 can connect to peripheral devices, such as disk units 40 and tape drives 42, or other program storage devices that are readable by the system. The server 106 can read the inventive instructions on the program storage devices and follow these instructions to execute the methodology of the embodiments herein.

The server 106 further includes a user interface adapter 24 that connects a keyboard 28, mouse 30, speaker 32, microphone 34, and/or other user interface devices such as a touch screen device (not shown) or a remote control to the bus 12 to gather user input. The server 106 also comprises a transceiver 10 for transferring and receiving information across a computing device/computing system/computing unit. Additionally, a communication adapter 22 connects the bus 12 to a data processing network 44, and a display adapter 26 connects the bus 12 to a display device 36 which may be embodied as an output device such as a monitor, printer, or transmitter, for example.

The method of the present disclosure can be implemented, in part or in whole, as software, hardware, or any combination thereof. In some embodiments, one or more processes, functions, tasks, and/or operations of the method can be carried out or performed by software routines, software processes, hardware, and/or any combination thereof. In some embodiments, the method of the present disclosure may be implemented, in part or in whole, as software running on one or more computing devices or systems, such as on the server 106 or the user device 102. For example, whole method or at least a step of the whole method thereof can be implemented as or within an application (e.g., app), a program, or an applet, etc., running on the computing device. It should be understood that there can be many variations or other possibilities to implement the system and method of the present disclosure.

In some embodiments, the server 106 is a software as a service (SaaS) server which is hosted on a cloud architecture, thereby enabling users to access the method of the present disclosure implemented as the application or software remotely over the network 104. The server 106 enables the user to access the application after receiving user credentials and authenticating the user device 102 on a subscription basis. The application or software is typically accessed through, but not limited to, a browser, a web-based portal, a desktop software, a mobile application, an application programming interface (API), presented on the user device 102. It is to be noted that any other existing techniques can be used to access the application or software hosted on the server 106. In some embodiments, the server 106 may be on-premises server. While the above description contains specific details regarding certain elements, embodiments, and other teachings, it is understood that embodiments of the disclosure or any combination of them may be practiced without these specific details. These details should not be construed as limitations on the scope of any embodiment, but merely as exemplifications of the presently preferred embodiments. In other instances, well known structures, elements, and techniques have not been shown to clearly explain the details of the disclosure.

What is claimed is:

1. A system for analyzing insurance documents and recommending an optimum insurance product, comprising:
a server comprising:
a memory to store one or more modules; and
a processor configured to execute the one or more modules to perform:
receiving two or more insurance documents associated with insurance products from a user device, wherein the insurance documents is at least one of an insurance quote document, an insurance policy document, an insurance contract, a certificate of insurance (COI) request form, or combination thereof;
determining a plurality of entities from each insurance document using a combination of one or more machine learning models and one or more large language models, wherein the plurality of entities correspond to at least one of an quote information, a policy information, an insurance contract information, an insurance request information or combination thereof;
augmenting, using an augmentation module, the plurality of entities using data from third part data sources;
contextualizing and summarizing, using a contextualizing and summarizing module, contents of a plurality of clauses of the two or more insurance documents at a document level using a clause library and a domain specific prompt library;
comparing, using a comparison module, a plurality of augmented entities and the plurality of clauses by leveraging contextualized and summarized contents of the two or more insurance documents, across the two or more insurance documents; and
generating, on a user interface, a side-by-side comparison of the plurality of augmented entities and the plurality of clauses against quote asks across the two or more insurance documents based on comparison of the two or more insurance documents.

2. The system of claim 1, wherein, after receiving the two or more insurance documents from the user device, the processor is configured to
classify, using a classification, transformation and enhancing (CTE) module, each insurance document based on a type and a line of business that each insurance document associated with;
identify, using a context filtering module, one or more pages of each insurance document comprising at least one of a quote data, a policy data, or an insurance contract data, a COI request data, combination thereof; and
trigger, using a triggering module, one or more models for comparison of the two or more insurance documents based on classification of each insurance document and identified pages of each insurance document, wherein the processor is further configured to provide identified pages of each insurance document as an input to triggered one or more models.

3. The system of claim 1, wherein the processor determines the plurality of entities from each insurance document by
identifying, using an entity recognition module, the plurality of entities that are immediately apparent from the two or more insurance documents using the domain specific prompt library;
determining, using quote and policy models, relationship between identified entities and the plurality of clauses, further, to determine whether changes in clauses impact applicability, values, and interactions of the identified entities within the insurance documents; and
contextualizing and extracting, using a contextual extraction module, the plurality of entities that are not be immediately apparent in the two or more insurance documents by leveraging relationship determined by the quote and policy models.

4. The system of claim 1, wherein the processor is further configured to color code differences and similarities across the two or more insurance documents with respect to entities and clauses associated with each insurance document.

5. The system of claim 1, wherein the processor is further configured to generate, on the user interface, a side-by-side comparison across source documents of the two or more insurance documents with respect to entities and clauses associated with each insurance document.

6. The system of claim 1, wherein the plurality of entities comprises at least one of a name of an insured, an address of the insured, a policy number, a name of a carrier, a location schedule, an agency name and address, terrorism, limits, premium, dates, deductibles, exclusions, endorsements, coverage types, a name of COI requester name, an address of COI requester, a name of COI holder, an address of COI holder, a project information, or combination thereof.

7. The system of claim 1, wherein the plurality of clauses comprises at least one of an exclusion clause, an endorsement clause, definitions, coverage terms, conditions, limitations, premium payment terms, a cancellation clause, a renewal clause, a dispute resolution clause, a territorial limits clause, subrogation, co-insurance clause, or a liability clause.

8. The system of claim 1, wherein the processor is further configured to summarize, using a summarization module, a comparison data of the two or more insurance documents.

9. The system of claim 1, wherein, when the two or more insurance documents comprise at least one of two or more insurance quote documents, corresponding two or more insurance policy documents, or combination thereof, the processor is further configured to recommend, using a recommendation module, the optimum insurance coverage by leveraging comparison data of the two or more insurance documents.

10. The system of claim 1, wherein the processor is further configured to generate placement insights by analyzing a plurality of historical insurance products opted by various customers in different line of business and determining trends and patterns of at least one of purchasing of coverages, limits, premium ranges, and endorsements, purchasing of insurance products, common exclusions, top carriers by premium, top brokers by carrier according to a line of business.

11. The system of claim 10, wherein the processor is further configured to
recommend at least one of optimum insurance products, insurance carriers, insurance brokers, or an insurance market for a customer based on the placement insights; and
obtain the plurality of insurance documents based on recommended insurance products and/or insurance carriers or market, for comparison.

12. The system of claim 10, wherein the processor is further configured to recommend, using the recommendation module, the optimum insurance product based on comparison of the two or more insurance documents as well as based on at least one of the placement insights, north american industry classification system (NAICS) code or standard industrial classification (SIC) code, revenue and other business profile, state or jurisdiction of operations a line of business, and insurer's risk to appetite.

13. The system of claim 1, wherein, when the two or more insurance documents comprise a new insurance policy and at least one of prior year insurance policy, the processor is further configured to
identify at least one of errors and omissions, and any coverage gaps in the new insurance policy over the at least one of prior year insurance policy by leveraging comparison data of the two or more insurance documents; and
communicate identified errors and omissions and/or any coverage gaps to corresponding parties to revise quote offering and/or policies, wherein revised quote offering and/or policies are further used for comparison.

14. The system of claim 1, wherein, when the two or more insurance documents comprise the insurance contract and the COI request form, the processor is configured to
generate, using a COI generation module, a certificate of insurance (COI) by leveraging comparison data of the two or more insurance documents, wherein the COI provides a proof of insurance coverage for an insured.

15. The system of claim 1, wherein the processor is further configured to create, using a scoring module, an accuracy score indicating an accuracy of extracted information across the insurance documents and an automation score indicating level of automation achieved in identifying, extracting, comparing, and summarizing data across the insurance documents.

16. A computer implemented method for analyzing insurance documents and recommending an optimum insurance product, comprising:
receiving two or more insurance documents associated with insurance products from a user device, wherein the insurance documents is at least one of an insurance quote document, an insurance policy document, an insurance contract, a certificate of insurance (COI) request form, or combination of thereof;
determining a plurality of entities from each insurance document using a combination of one or more machine learning models and one or more large language models, wherein the plurality of entities correspond to at least one of an quote information, a policy information, an insurance contract information, an insurance request information or combination thereof;
augmenting, using an augmentation module, the plurality of entities using data from third part data sources;
contextualizing and summarizing, using a contextualizing and summarizing module, contents of a plurality of clauses of the two or more insurance documents at a document level using a clause library and a domain specific prompt library;
comparing, using a comparison module, a plurality of augmented entities and the plurality of clauses by leveraging contextualized and summarized contents of the two or more insurance documents across the two or more insurance documents; and
generating, on a user interface, a side-by-side comparison of the plurality of augmented entities and the plurality of clauses against quote asks across the two or more insurance documents based on comparison of the two or more insurance documents.

17. The method of claim 16, after receiving the two or more insurance documents from the user device, comprising:
classify, using a classification, transformation and enhancing (CTE) module, each insurance document based on a type and a line of business that each insurance document associated with;
identify, using a context filtering module, one or more pages of each insurance document comprising at least one of a quote data, a policy data, or an insurance contract data, a COI request data, or combination thereof; and
trigger, using a triggering module, one or more models for comparison of the two or more insurance documents based on classification of each insurance document and identified pages of each insurance document, wherein the processor is further configured to provide identified pages of each insurance document as an input to triggered one or more models.

18. The method of claim 16, wherein determining the plurality of entities from each insurance document comprises
identifying, using an entity recognition module, the plurality of entities that are immediately apparent from the two or more insurance documents using the domain specific prompt library;
determining, using quote and policy models, relationship between identified entities and the plurality of clauses, further, to determine whether changes in clauses impact applicability, values, and interactions of the identified entities within the insurance documents; and
contextualizing and extracting, using a contextual extraction module, the plurality of entities that are not be immediately apparent in the two or more insurance documents by leveraging relationship determined by the quote and policy models.

19. The method of claim 16, further comprising color coding differences and similarities across the two or more insurance documents with respect to entities and clauses associated with each insurance document.

20. The method of claim 16, further comprising generating, on a user interface, a side-by-side comparison across source documents of the two or more insurance documents with respect to entities and clauses associated with each insurance document.

21. The method of claim 16, wherein the plurality of entities comprises at least one of a name of an insured, an address of the insured, a policy number, a name of a carrier, a location schedule, an agency name and address, terrorism, limits, premium, dates, deductibles, exclusions, endorsements, coverage types, a name of COI requester name, an address of COI requester, a name of COI holder, an address of COI holder, a project information, or combination thereof.

22. The method of claim 16, wherein the plurality of clauses comprises at least one of an exclusion clause, an endorsement clause, definitions, coverage terms, conditions, limitations, premium payment terms, a cancellation clause, a renewal clause, a dispute resolution clause, a territorial limits clause, subrogation, co-insurance clause, or a liability clause.

23. The method of claim 16, further comprising summarizing, using a summarization module, a comparison data of the two or more insurance documents.

24. The method of claim 16, when the two or more insurance documents comprise at least one of two or more insurance quote documents, corresponding two or more insurance policy documents, or combination thereof, further comprising recommending, using a recommendation module, the optimum insurance coverage by leveraging comparison data of the two or more insurance documents.

25. The method of claim 16, further comprising generating placement insights by analyzing a plurality of historical insurance products opted by various customers in different line of business and determining trends and patterns of at least one of purchasing of coverages, limits, premium ranges, and endorsements, purchasing of insurance products, common exclusions, top carriers by premium, top brokers by carrier according to a line of business.

26. The method of claim 16, further comprising
recommending at least one of optimum insurance products, insurance carriers, insurance brokers, or an insurance market for a customer based on the placement insights; and
obtaining the plurality of insurance documents based on recommended insurance products and/or insurance carriers or market, for comparison.

27. The method of claim 16, further comprising recommending, using the recommendation module, the optimum insurance product based on comparison of the two or more insurance documents as well as based on at least one of the placement insights, north american industry classification system (NAICS) code or standard industrial classification (SIC) code, revenue and other business profile, state or jurisdiction of operations a line of business, and insurer's risk to appetite.

28. The method of claim 16, when the two or more insurance documents comprise a new insurance policy and at least one of prior year insurance policy, further comprising
identifying at least one of errors and omissions, and any coverage gaps in the new insurance policy over the at least one of prior year insurance policy by leveraging comparison data of the two or more insurance documents; and
communicating identified errors and omissions and/or any coverage gaps to corresponding parties to revise quote offering and/or policies, wherein revised quote offering and/or policies are further used for comparison.

29. The method of claim 16, further comprising creating, using a scoring module, an accuracy score indicating an accuracy of extracted information across the insurance documents and an automation score indicating level of automation achieved in identifying, extracting, comparing, and summarizing data across the insurance documents.

30. A computer program product comprising a non-transitory computer-readable storage medium having computer-readable instructions stored thereon, computer-readable instructions being executable by a computerized device comprising processing hardware to execute a method comprising steps of:
receiving two or more insurance documents associated with insurance products from a user device, wherein the insurance documents is at least one of an insurance quote document, an insurance policy document, an insurance contract, a certificate of insurance (COI) request form, or combination of thereof;
determining a plurality of entities from each insurance document using a combination of one or more machine learning models and one or more large language models, wherein the plurality of entities correspond to at least one of an quote information, a policy information, an insurance contract information, an insurance request information or combination thereof;
augmenting, using an augmentation module, the plurality of entities using data from third part data sources;
contextualizing and summarizing, using a contextualizing and summarizing module, contents of a plurality of clauses of the two or more insurance documents at a document level using a clause library and a domain specific prompt library;
comparing, using a comparison module, a plurality of augmented entities and the plurality of clauses by leveraging contextualized and summarized contents of the two or more insurance documents across the two or more insurance documents; and
generating, on a user interface, a side-by-side comparison of the plurality of augmented entities and the plurality of clauses against quote asks across the two or more insurance documents based on comparison of the two or more insurance documents.
